(19) United States
(12) Patent Application Publication
(10) Pub. No.: US 2026/0109834 A1
(43) Pub. Date: Apr. 23, 2026

(54) Polymers and Methods of Depolymerization of Polymers Using Chain-End Initiation

(71) Applicant: University of Florida Research Foundation, Inc., Gainesville, FL (US)

(72) Inventors: Brent S. SUMERLIN, Gainesville, FL (US); John B. GARRISON, Gainesville, FL (US); James Bailey YOUNG, Gainesville, FL (US); Rhys William HUGHES, Gainesville, FL (US)

(21) Appl. No.: 18/926,955

(22) Filed: Oct. 25, 2024

Related U.S. Application Data
(60) Provisional application No. 63/592,944, filed on Oct. 25, 2023.
(60) Provisional application No. 63/563,490, filed on Mar. 11, 2024.

(51) Int. Cl. C08J 11/12; C08F 112/08; C08F 120/06

(52) U.S. Cl. CPC C08J 11/12; C08F 112/08; C08F 120/06; C08J 2325/06; C08J 2333/12

(57) ABSTRACT

The present disclosure provides for bulk depolymerization of polymers at significantly lower temperatures than possible through currently available methods. The present disclosure provides for polymers and modified polymers that include at least one thermolytically labile end-group.

### CROSS-REFERENCE TO RELATED APPLICATION

This application claims priority to U.S. provisional application entitled “Polymers and Methods of Depolymerization of Polymers Using Chain-End Initiation” having Ser. No. 63/563,490 filed on Mar. 11, 2024 and U.S. provisional application entitled “Compositions, Systems and Methods for Bulk Depolymerization of Polymethyl Methacrylate Copolymers via Pendent Group Initiation” having Ser. No. 63/592,944 filed on Oct. 25, 2023, which are entirely incorporated herein by reference.

### STATEMENT REGARDING FEDERALLY SPONSORED RESEARCH OR DEVELOPMENT

This invention was made with government support under Grant Numbers 1904631 and 1941529, awarded by the National Science Foundation; and Grant Numbers W911NF-17-1-0326 and W911NF-23-1-0260, awarded by the US Army Research Office. The government has certain rights in the invention.

### BACKGROUND

Polymer recycling is an important area with the increased use of polymer in most consumer products. There are two categories of polymer recycling: thermomechanical recycling and chemical recycling. Thermomechanical recycling often results in a reduction in the molecular weight and mechanical properties of the recycled polymer, while chemical recycling is an approach to convert polymer into monomer or its precursor forms.

### SUMMARY

The present disclosure provides for bulk depolymerization of polymer (e.g., poly(methyl methacrylate) (PMMA)) at significantly lower temperatures than possible through currently available methods. The present disclosure provides for polymers and modified polymers that include at least one thermolytically labile end-group.

The present disclosure provides for a composition comprising: a polymer having at least one of an α-chain end group (V) and an ω-chain end group (W), wherein V is selected from:

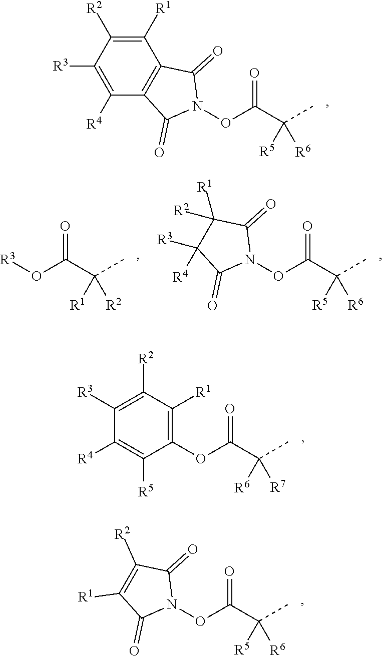

wherein W is selected from:

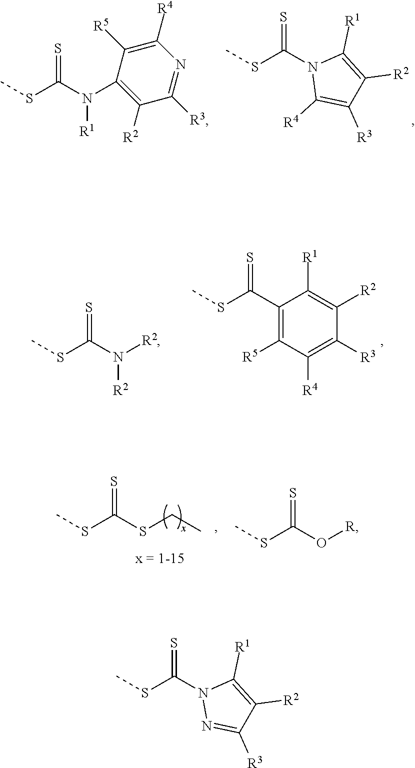

where the dashed line is the bond to the polymer, wherein x is 1 to 15, wherein each of R, R¹, R², R³, R⁴, R⁵, R⁶, and R⁷ are independently selected from: H, an alkyl group, halogen, —CN group, —NO₂ group, —O-alkyl group, an aryl group.

The present disclosure provides for a method of depolymerization of a polymer comprising: adding at least one of an α-chain end group (V) and/or an ω-chain end group (W) to the polymer to form a modified polymer, wherein V is selected from:

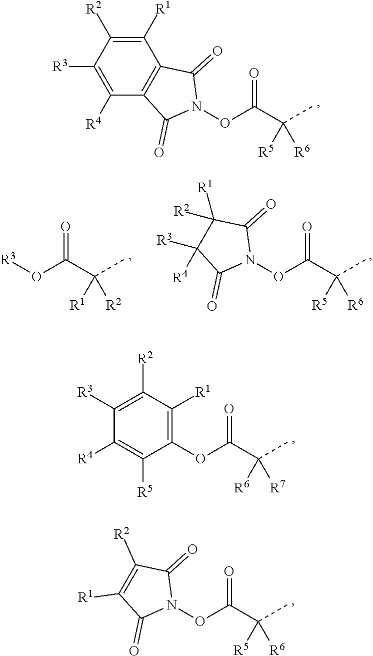

wherein W is selected from:

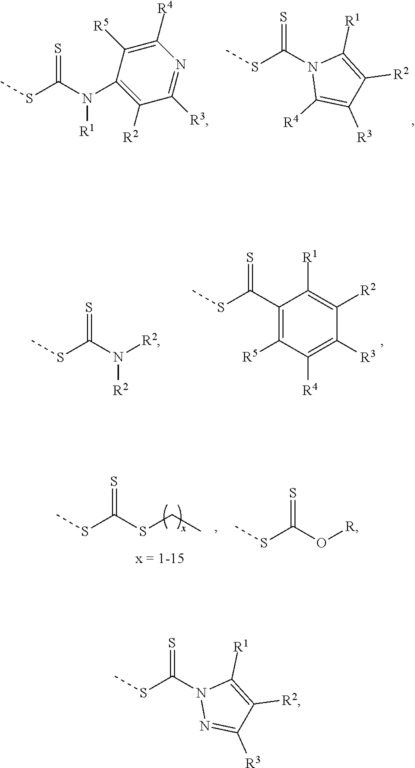

where the dashed line is the bond to the polymer, each of R, R¹, R², R³, R⁴, R⁵, R⁶, and R⁷ are independently selected from: H, an alkyl group, halogen, —CN group, —NO₂ group, —O-alkyl group, an aryl group, heating the modified polymer to about 180 to 300° C.; and depolymerization of the modified polymer, wherein about 90% of the monomer units are recovered.

The present disclosure provides for a method of depolymerization a polymer comprising: heating the polymer to about 180 to 300° C., wherein the polymer is selected from the polymer described above or herein; and depolymerization of the modified polymer, wherein about 90% of the monomer units are recovered.

### BRIEF DESCRIPTION OF DRAWINGS

Further aspects of the present disclosure will be more readily appreciated upon review of the detailed description of its various embodiments, described below, when taken in conjunction with the accompanying drawings.

FIGS. 1A-1C illustrates the chemical recycling of PMMA to MMA utilizing labile end-groups. FIG. 1A illustrates initiation of depolymerization from α-chain ends, ω-chain ends, or a combination of the two. FIG. 1B illustrates the structures of the studied reversible addition-fragmentation chain transfer (RAFT) polymerization. FIG. 1C illustrates the structures of the studied atom transfer radical polymerization (ATRP) initiators.

FIGS. 2A and 2B illustrate the extent of PMMA depolymerization utilizing RAFT end-groups. FIG. 2A illustrates the Thermogravimetric analysis (TGA) traces of poly(methyl methacrylate) (PMMA) with various ω-chain ends derived from reversible addition-fragmentation chain transfer (RAFT) polymerization. FIG. 2B illustrates the extent of depolymerization of PMMA to methyl methacrylate (MMA) monomer as a function of ω-end-group identity, as determined by the extent of depolymerization prior to the plateaus in which no further mass loss is observed. Structures of studied RAFT agents are detailed in FIG. 1B.

FIGS. 3A and 3B illustrate the extent of PMMA depolymerization utilizing ATRP end-groups. FIG. 3A illustrates the thermogravimetric analysis traces of poly(methyl methacrylate) (PMMA) with various a/o-chain ends derived from atom-transfer radical polymerization (ATRP). FIG. 3B illustrates the extent of depolymerization of PMMA to methyl methacrylate (MMA) monomer as a functional of end-group identity, as determined by the extent of depolymerization prior to the plateaus in which no further mass loss is observed. Structures of the studied ATRP initiators are detailed in FIG. 1C.

FIGS. 4A and 4B illustrate depolymerization dependence on molecular weight. FIG. 4A depicts the structures of PMMA with various a/o end-groups. FIG. 4B illustrates an examination of the dependence of the percent depolymerization on molecular weight (Mₙ) for ω, α, and α/ω functionalized PMMA. PMMA of various molecular weights and end-groups were subjected to TGA at a heating rate of 10° C./min over a range of 20-500° C. The extent of depolymerization was determined by the percent mass loss up until the observed plateau prior to the degradation temperature of 376° C.

FIGS. 5A-5C illustrate the depolymerization of PMMA utilizing telechelic end-groups for reversion to monomer. FIG. 5A illustrates a thermogravimetric analysis (TGA) of difunctional Phth-PMMA-TTC with hashmarks representing the corresponding scans in FIG. 5C. FIG. 5B illustrates size exclusion chromatography traces of a 5.4 kg/mol difunctional Phth-PMMA-TTC relative to a 298 kg/mol polystyrene standard after two parallel isothermal holds at 180 and 290° C. FIG. 5C illustrates TGA-tandem mass spectrometry scans of a 5.4 kg/mol difunctional Phth-PMMA-TTC with key masses highlighted in orange. Ion fragment masses are detailed in Table S2.

FIGS. 6A-6D illustrate bulk depolymerization of PMMA to MMA. FIG. 6A depicts bulk depolymerization set-up of PMMA to MMA. FIG. 6B depicts an image of the bulk polymer and the recovered MMA. FIG. 6C illustrates synthesized PMMA bearing different end-groups with quantity of monomer recovered after bulk depolymerization. FIG. 6D illustrates the ¹H NMR spectrum of the recovered MMA.

FIGS. 7A-7C illustrates SCULPT depolymerization to monomodal polymer distributions. Size-exclusion chromatography (SEC) traces displaying the ability to depolymerize FIG. 7A blends with high molecular weight shoulders, FIG. 7B blends with low molecular weight shoulders, and FIG. 7C both high and low molecular weight shoulders from polymer blends, through their activatable chain ends with time. The unfunctionalized PMMA-H (12.0 kg/mol, Ð=1.01) polymer trace is represented as a dotted line as a reference to the final molecular weight distributions achieved via the skew customization by unzipping layered polymer traces (SCULPT) method.

FIG. 8 illustrates schematically end functionality of polymers for depolymerization.

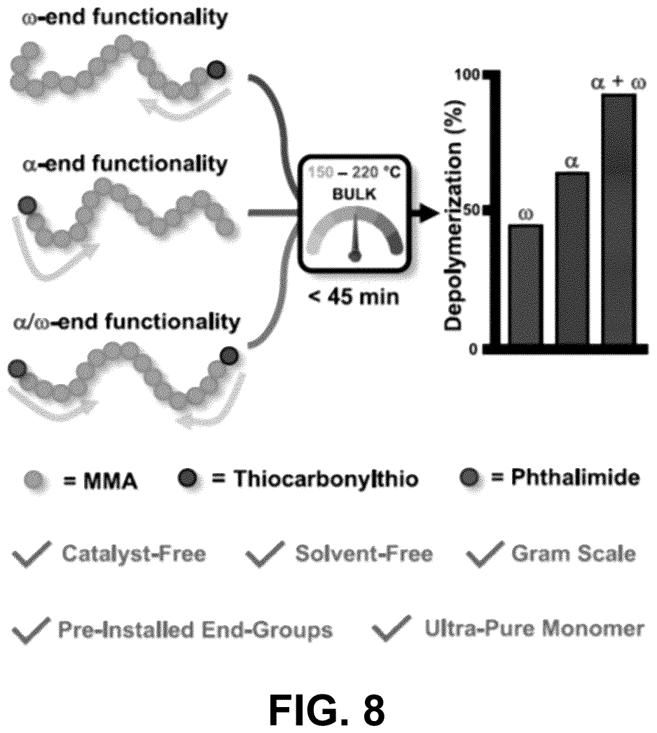

FIGS. 9A-9C illustrate investigation into the effect of temperature ramp rate on onset depolymerization. FIG. 9A depicts PMMA-TTC. FIG. 9B illustrates Phth-PMMA. FIG. 9C illustrates Phth-PMMA-TTC.

FIG. 10 illustrates ¹H NMR spectrum of the PMMA-DTB after an isothermal hold at 180° C. for 15 min. The appearance of two alkene peaks at 5.48 and 6.21 ppm indicates terminal alkene formation via the Chugaev mechanism. Residual MMA alkene peaks can be seen at 5.57 and 6.12 ppm.

FIG. 11 illustrates the change in color of PMMA-DTB-H after thermal treatment. Image of PMMA-DTB (left) prior to thermal treatment and PMMA-DTB (right) after an isothermal hold at 180° C. for 15 min, suggesting the loss of dithiobenzoate chain ends.

FIG. 12 illustrates thermogravimetric analysis (TGA) trace displaying the mass loss of PMMA-DTB-H throughout a ramp rate of 10° C./min to 220° C. with a subsequent isothermal hold at 220° C. for 120 min. The sample underwent a second isothermal hold at 310° C. for 120 min, upon which a final mass loss of 62% was observed.

FIG. 13 illustrates size-exclusion chromatography traces for the synthesis of 9 kg/mol PMMA by SARA ATRP using phthalimidyl bromoisobutyrate.

FIG. 14 illustrates ¹H NMR spectrum of 1,3-dioxoisoindolin-2-yl 2-(((dodecylthio)carbonothioyl)thio)-2-methylpropanoate (Phth-TTC).

FIG. 15 illustrates ¹³C NMR spectrum of 1,3-dioxoisoindolin-2-yl 2-(((dodecylthio)carbonothioyl)thio)-2-methylpropanoate (Phth-TTC).

FIG. 16 illustrates size-exclusion chromatography traces for the photoiniferter polymerization of MMA with 1,3-dioxoisoindolin-2-yl 2-(((dodecylthio)carbonothioyl)thio)-2-methylpropanoate (Phth-TTC) under 450 nm light.

FIG. 17 illustrates thermogravimetric analysis (TGA) traces of various molecular weight unfunctionalized and functionalized PMMA at isothermal holds of 220° C. for 90 min. Polymer samples underwent a ramp rate of 10° C./min prior to the isothermal hold for 90 min.

FIG. 18 illustrates size exclusion chromatography traces of a 5.4 kg/mol difunctional Phth-PMMA-TTC displaying the reduction in the dRI trace after an isothermal at 290° C. Phth-PMMA-TTC and after an isothermal hold at 290° C. for 20 min.

FIG. 19 illustrates percent depolymerization as a function of temperature as measured by size-exclusion chromatography, thermogravimetric analysis, and ¹H NMR spectroscopy. The percent depolymerization measured using the three techniques differed by no more than 4%.

FIG. 20 illustrates discrete ion mass tracking of various products seen during depolymerization of Phth-PMMA-TTC. The evolution of MMA (100 g/mol) over time correlates to the three onsets of depolymerization observed from the TTC end, the Phth end, and finally degradation of the remaining polymer product. Peak production of carbon disulfide can be seen at the first onset of depolymerization occurring from the degradation of the TTC iniferter. Finally, carbon dioxide can be seen increasing over time, correlating to the degree of Phth chains initiated for depolymerization.

FIG. 21 illustrates mass spectrometry analysis of unfunctionalized PMMA-H (12 kg/mol) at 400° C. with key masses highlighted.

FIG. 22 illustrates ¹H NMR spectrum of recovered polymer product from the bulk depolymerization of Phth-PMMA-TTC. In addition to the multiple degradation products of end groups observed, including the residual PMMA, two new alkene peaks corresponding to the a-end disproportionation products appear at 4.78 and 4.60 ppm.

FIG. 23 illustrates ¹H NMR spectrum of recovered polymer product from the bulk depolymerization of PMMA-TTC.

FIG. 24 illustrates ¹H NMR spectrum of recovered polymer product from the bulk depolymerization of Phth-PMMA. Analysis of the α-end of the polymer shows a mixture of endo and exo alkene termination.

FIG. 25 illustrates collected polymer product after bulk depolymerization of Phth-PMMA-TTC. An initial quantity of 1.097 g of polymer was placed in the bulk depolymerization setup, with 0.086 g of polymer product recovered, indicating that 92% of the polymer mass was depolymerized. Of that depolymerization percentage, 0.93 mL of MMA was recovered from a theoretical 1.06 mL representing 88% monomer recovery.

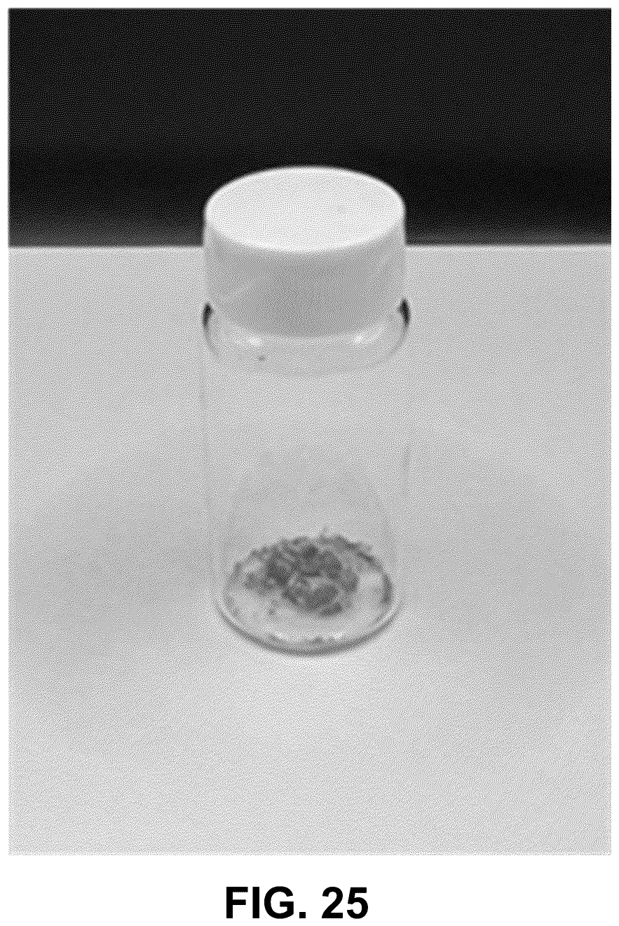

FIG. 26 illustrates ¹H NMR spectrum of recovered MMA from the bulk depolymerization of Phth-PMMA-TTC.

FIG. 27 illustrates ¹H NMR spectrum of recovered MMA from the bulk depolymerization of PMMA-TTC.

FIG. 28 illustrates size-exclusion chromatography trace of the PMMA (Mₙ, theoretical=5.0 kg/mol, Mₙ, SEC=4.8 kg/mol) synthesized via photoiniferter polymerization under 450 nm light using the recovered methyl methacrylate (MMA). The recovered MMA was obtained from the bulk depolymerization of the Phth-PMMA-TTC.

FIG. 29 illustrates solvent-cast films of PMMA with various end-groups. PMMA-TTC (left), Phth-PMMA (middle), and Phth-PMMA-TTC (right) polymer products show the effect of end group on the color and transparency of the solvent cast PMMA.

FIG. 30 illustrates differential scanning calorimetry (DSC) analysis of PMMA with various end groups. The glass transition temperature (T_{g}) is observed as an endothermic inflection and decreases as the end-group size increases for the Phth-PMMA (6.1 kg/mol, T_{g}=95.1° C.), PMMA-TTC (5.0 kg/mol, T_{g}=92° C.), and Phth-PMMA-TTC (5.4 kg/mol, T_{g}=90° C.). Molecular weights were kept within 1 kg/mol to mitigate chain-length effects on T_{g}.

### DETAILED DESCRIPTION

The present disclosure provides for bulk depolymerization of polymer (e.g., poly(methyl methacrylate) (PMMA)) at significantly lower temperatures than possible through currently available methods. The present disclosure provides for polymers and modified polymers that include at least one thermolytically labile end-group (e.g., α-end N-hydroxyphthalimide ester (or variations thereof) N-hydroxysuccinimde ester (or variations of) or alkyl ester and/or ω-end dithioester, dithiocarbamate, xanthate or trithiocarbonate).

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, tribo-/rheology, and the like, which are within the skill of the art.

The following examples are put forth so as to provide those of ordinary skill in the art with a complete disclosure and description of how to perform the methods and use the compositions, methods, and materials disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

As used herein, the following terms have the meanings ascribed to them unless specified otherwise. In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. Patent law and the term is open-ended, allowing for the presence of more than that which is recited so long as basic or novel characteristics of that which is recited is not changed by the presence of more than that which is recited, but excludes prior art embodiments.

### Definitions

By “chemically feasible” is meant a bonding arrangement or a compound where the generally understood rules of organic structure are not violated. The structures disclosed herein, in all of their embodiments are intended to include only “chemically feasible” structures, and any recited structures that are not chemically feasible, for example in a structure shown with variable atoms or groups, are not intended to be disclosed or claimed herein. However, if a bond appears to be intended and needs the removal of a group such as a hydrogen from a carbon, the one of skill would understand that a hydrogen could be removed to form the desired bond.

It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

“Polymers” are understood to include, but are not limited to, homopolymers, copolymers, such as for example, block, graft, random and alternating copolymers, terpolymers, etc. and blends and modifications thereof.

As used herein, “alkyl” or “alkyl group” refers to a saturated aliphatic hydrocarbon, which can be straight or branched, having 1 to 40, 1 to 20, 1 to 10, or 1 to 5 carbon atoms, where the stated range of carbon atoms includes each intervening integer individually, as well as sub-ranges. Examples of alkyl groups include, but are not limited to methyl, ethyl, n-propyl, i-propyl, n-butyl, s-butyl, t-butyl, n-pentyl, and s-pentyl. Reference to “alkyl” or “alkyl group” includes unsubstituted and substituted forms of the hydrocarbon moiety.

As used herein, “halo”, “halogen”, or “halide”, refers to a fluorine, chlorine, bromine, iodine, and astatine, and radicals thereof. Further, when used in compound words, such as “haloalkyl” refers to an alkyl or alkenyl radical in which one or more hydrogens are substituted by halogen radicals.

The term “unsaturated” refers to a molecule, such as a hydrocarbon or hydrocarbon moiety that includes one or more double bonds and/or triple bonds.

“Aryl”, as used herein, refers to C₅-C₂₀-membered aromatic, heterocyclic, fused aromatic, fused heterocyclic, biaromatic, or bihetereocyclic ring systems. In an aspect, “aryl”, can include 5-, 6-, 7-, 8-, 9-, and 10-membered single-ring aromatic groups that may include from zero to four heteroatoms, for example, functional groups that correspond to benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems (C₅-C₃₀) having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbonyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, 4-piperidinyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienoimidazolyl, thiophenyl, 1,2,3-triazole, 1,2,4-triazole and xanthenyl. One or more of the rings can be substituted as defined above for “aryl”.

In some aspects, a structure of a compound can be represented by a formula:

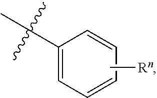

which is understood to be equivalent to a formula:

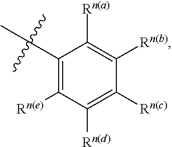

wherein n is typically an integer. That is, Rⁿ is understood to represent five independent substituents, R^{n(a)}, R^{n(b)}, R^{n(c)}, R^{n(d)}, and R^{n(e)}. By “independent substituents,” it is meant that each R substituent can be independently defined. For example, if in one instance R^{n(a)} is halogen, then R^{n(b)} is not necessarily halogen in that instance.

### Discussion:

The present disclosure provides for polymers and modified polymers and methods of depolymerization of polymers and modified polymers. The present disclosure provides for polymers and modified polymers that include at least one thermolytically labile end-group (e.g., α-end N-hydroxyphthalimide ester (or variations of), N-hydroxysuccinimde ester (or variations of), phenyl ester (or variations of), or alkyl ester and/or ω-end dithioester, dithiocarbamate, xanthate or trithiocarbonate). In addition, the present disclosure provides for bulk depolymerization of polymers (e.g., poly(methyl methacrylate) (PMMA)) at significantly lower temperatures (e.g., about 50-250° C. lower) than possible through currently available methods. In an aspect, the combination of an α-end N-hydroxyphthalimide ester or alkyl ester and an ω-end trithiocarbonate or dithiocarbamate or dithioester allowed for near quantitative depolymerization in the bulk, with about 90% or more of the monomer recovered for subsequent repolymerization. The present disclosure can be advantageous in that depolymerization can be performed without the use of a catalyst and/or a solvent to revert to the monomer on a multigram scale at temperatures lower than current industrial methods. The present disclosure should also be useful to provide for an efficient and high-yielding route to depolymerize on a large scale.

In an aspect, the present disclosure provides for a composition that includes a polymer (e.g., also referred to a modified polymer when end groups are added to already formed polymers) that includes at least one thermally labile end-group which may include an α-end N-hydroxyphthalimide ester (or variations of), N-hydroxysuccinimde ester (or variations of), phenyl ester (or variations of), or alkyl ester and/or ω-end dithioester, dithiocarbamate, xanthate or trithiocarbonate or other thermally labile end-groups. The molecular weight of the polymer can be about 1-10,000 kg/mol.

In an aspect, the polymer has at least one of a α-chain end group (V) and a ω-chain end group (W). In an aspect, both V and W are present.

In an aspect, V can be selected from:

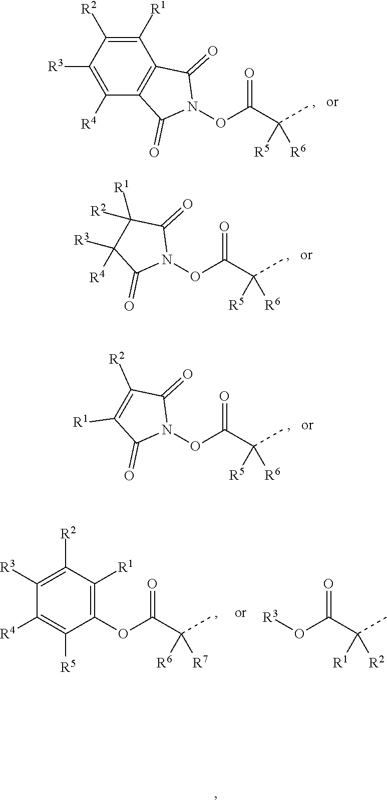

where each of R¹, R², R³, R⁴, R⁵, R⁶, and R⁷ can be independently selected from: H, an alkyl group (e.g., methyl, ethyl, propyl, butyl), halogen, —CN group, —NO₂ group, —O-alkyl group (e.g., —OMe group), an aryl group, (the dashed lines indicate the bond to the polymer backbone).

In an aspect, W can be selected from:

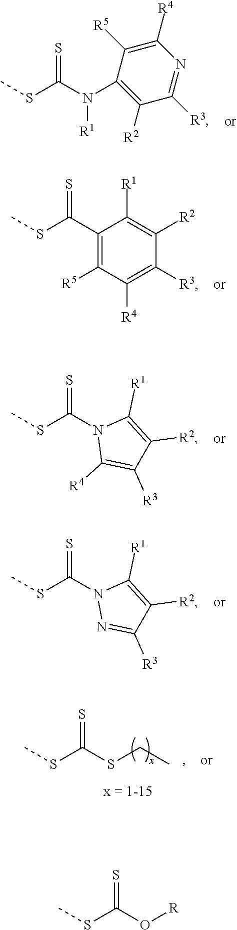

where each of R, R¹, R², R³, R⁴, R⁵, R⁶, and R⁷ can be independently selected from: H, an alkyl group (e.g., methyl, ethyl, propyl, butyl), halogen, —CN group, —NO₂ group, —O-alkyl group (e.g., —OMe group), and an aryl group, (the dashed lines indicate the bond to the polymer backbone)(e.g., alkyl is methyl, ethyl, propyl etc.).

In an aspect, the polymer can have the following polymer backbone:

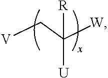

where x is 2 to 100,000 and where R is an alkyl group (e.g., methyl, ethyl, propyl, butyl). V and W are defined above. U can be a group that forms a monomer unit selected from: a methacrylate monomer, an alkyl ethacrylate, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these. In a particular aspect, the backbone unit can include a monomer unit or a copolymer including the monomer unit, where the monomer unit is selected from: alkyl methacrylates, acrylamide, N,N-dimethylacrylamide, N,N-dialkylacrylamides, N-alkylacrylamides, NN-dialkyl methacrylamides, N-alkyl methacrylamides, alkyl acrylates, oligo(ethylene glycol) acrylate, oligo(ethylene glycol) methacrylate, oligo(ethylene glycol) acrylamide, or oligo(ethylene glycol) methacrylamide, or substituted monomers units of each of these. The polymer can be a homopolymer or a copolymer or a blend of different polymers. In an aspect, the monomer unit is a methacrylate monomer unit (e.g., methyl methacrylate monomer unit) or a styrenic monomer unit. In an aspect, the polymer is a homopolymer (e.g., poly (methyl methacrylate) (PMMA)).

In an aspect, the polymer can be a block copolymer that can have the following polymer backbone:

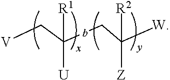

U, V, and W, are described above and x and y can each independently be 2 to 100,000. R¹ can be an alkyl group (e.g., methyl, ethyl, propyl, butyl). Z and R² form a non-depolymerizable polymer block such as a polystyrene group, a polyacrylate group, a polyethylene group. R² can be an alkyl group (e.g., methyl, ethyl, propyl, butyl).

In an embodiment, the polymer (e.g., homopolymer or co-polymer) or modified polymer (e.g., homopolymer or co-polymer) can be linear or non-linear such as star-like, branched, hyperbranched, comb/brush-like, graph copolymer, bottle brush-like, or cyclic. A linear polymer can be defined as a macromolecular structure comprised of monomeric units covalently linked together in a sequential and unidirectional manner, forming a single continuous chain. This architecture is devoid of crosslinks, side chains and network structures that would arise from connections between polymer chains.

A branched polymer can be defined as a macromolecular architecture where one or more side chains extend from the primary linear backbone. For example, this architecture can result from the incorporation of monomers with multiple reactive sites during the polymerization process. Branched polymers have inherently more chain-ends than linear polymers, this makes branched polymers useful since they can contain more thermally labile end groups that can be activated to initiate depolymerization. These side chains, which may vary in length, regularity, and density create a more complex heterogeneous topology compared to linear polymers. The degree of branching (DB) can be calculated by the equation:

$$DB = \frac{2 D}{2 D + L}$$

where D represents molar equivalents of dendritic or branching unit, and L represents molar equivalents of the linear unit. Herein, branched polymers can be defined as having a DB greater than 0 but less than 0.4.

A hyperbranched polymer can be defined as a macromolecular structure characterized by tree-like topology that differentiates it from conventional branched polymers. The defining feature of hyperbranched polymers is their high DB, which is greater than 0.4 but less than 1.

A star polymer can be defined as a macromolecular structure characterized by ‘arms’ extending from a central core. Star polymers have inherently more chain-ends than linear polymers, this makes star polymers useful since they can contain more thermally labile end groups that can be activated to initiate depolymerization. These ‘arms’, which may vary in length, regularity, and density create a more complex heterogeneous topology compared to linear polymers.

In an aspect, the backbone unit can include monomer units and copolymers including the monomer units. In an aspect, the polymer or modified polymer can be a block copolymer, a random copolymer, a statistical copolymer, an alternating copolymer, or a gradient copolymer.

A gradient copolymer is a polymer with more than one type of monomer unit where the frequency of occurrence of at least one monomer unit changes gradually along the polymer chain. A statistical copolymer is a copolymer in which the sequential distribution of the monomeric units obeys known statistical laws and is based on relative reactivities.

In another aspect, the present disclosure provides a method of depolymerization of polymer. The polymer can be a modified polymer that is modified to include an α-chain end group (V) and/or an ω-chain end group (W) or a polymer that was originally prepared with an α-chain end group (V) and/or an ω-chain end group (W). The polymer to be depolymerized includes those described above in reference to the composition of the present disclosure and those described within the Examples section.

In an aspect, the method of depolymerization of a polymer that originally did not include an α-chain end group (V) and/or an ω-chain end group (W) includes adding at least one of an α-chain end group (V) or an ω-chain end group (W) to the polymer to form a modified polymer. The polymer may be mechanically cleaved to create two chain-ends that can react with a functional group to create two polymers of lower molecular weight with thermally labile chain-ends. The installed functional group can then be thermally activated to initiate depolymerization.

In particular, extrusion, shear extrusion, sonication or ball milling may be used to induce cleavage of the polymer backbone. Two polymeric radicals are expected that can react with functional groups such as:

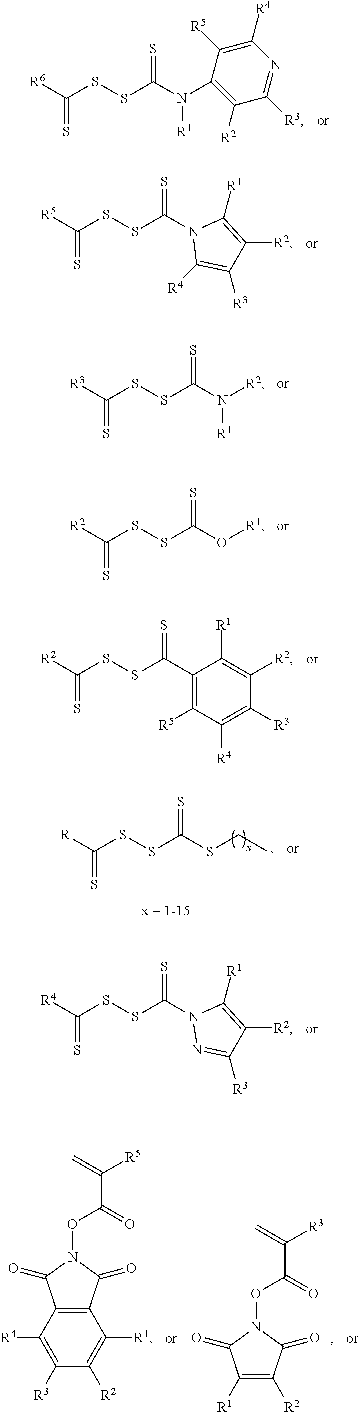

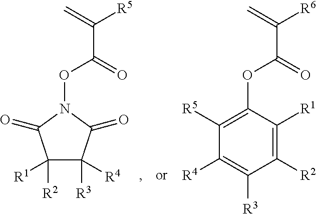

where each of R, R¹, R², R³, R⁴, R⁵, R⁶, and R⁷ can be independently selected from: H, an alkyl group (e.g., methyl, ethyl, propyl, butyl), halogen, —CN group, —NO₂ group, —O-alkyl group (e.g., —OMe group), an aryl group, (the dashed lines indicate the bond to the polymer backbone). V and W are described herein. The polymer can be a homopolymer or a copolymer as described herein. The modified polymer can be heated to a temperature of about 180 to 300° C. or 180 to 250° C. for a time frame of about 0.1 to 24 h or about 10 to 120 min. After sufficient time, the modified polymer is depolymerized into the original monomer units. In an aspect, about 80% or more (e.g., about 80 to 99%) or about 90% or more (e.g., about 90 to 99%) of the monomer units can be recovered. The method can be conducted in a catalyst-free environment (e.g., a catalyst is not added to the polymer during this method) and/or solvent-free environment (e.g., a solvent is not added to the polymer during this method). It should be noted that a minor amount of a catalyst and/or solvent may be present in the polymer that is a residual amount from the method of making the polymer, but additional catalyst and/or solvent is not added to the polymer for the present depolymerization process. In an aspect, the monomer unit of the polymer can be the methacrylate monomer unit such as methyl methacrylate monomer unit (e.g., a poly(methyl methacrylate) polymer).

In an aspect, the method of depolymerization of a polymer that originally includes an α-chain end group (V) and/or an ω-chain end group (W) includes heating the polymer to a temperature of about 180 to 300° C. or 180 to 250° C. for a time frame of about 0.1 to 24 h or about 10 to 120 min. After sufficient time, the polymer is depolymerized into the original monomer units. In an aspect, about 80% or more (e.g., about 80 to 99%) or about 90% or more (e.g., about 90 to 99%) of the monomer units can recovered. The polymer can be a homopolymer or a copolymer as described herein. The method can be conducted in a catalyst-free environment (e.g., a catalyst is not added to the polymer during this method) and/or solvent-free environment (e.g., a solvent is not added to the polymer during this method). It should be noted that a minor amount of a catalyst and/or solvent may be present in the polymer that is a residual amount from the method of making the polymer, but no additional catalyst and/or solvent is added to the polymer for the present depolymerization process. In an aspect, the monomer unit of the polymer can be the methacrylate monomer unit such as methyl methacrylate monomer unit (e.g., a poly(methyl methacrylate) polymer).

The following aspects provide for features and combinations of various embodiments of the present disclosure.
Aspect 1. The present disclosure provides for a composition comprising: a polymer having at least one of an α-chain end group (V) and an ω-chain end group (W), wherein V is selected from:

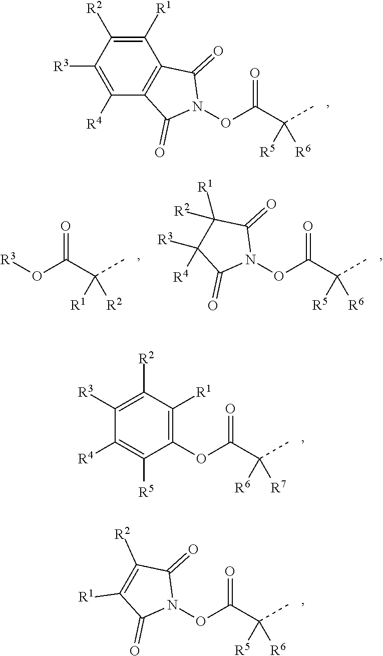

wherein W is selected from:

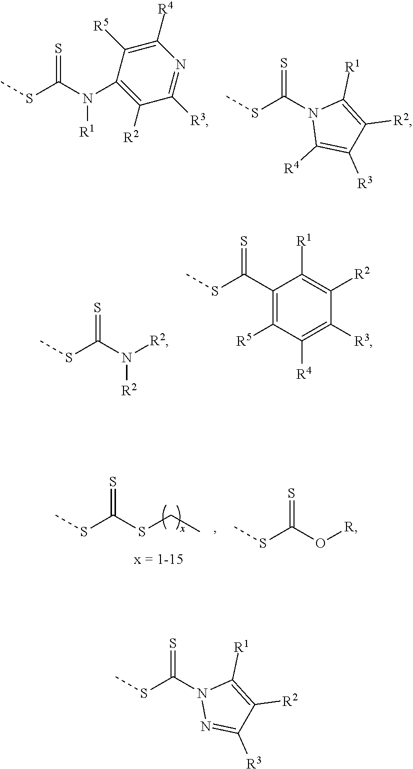

where the dashed line is the bond to the polymer, wherein x is 1 to 15, wherein each of R, R¹, R², R³, R⁴, R⁵, R⁶, and R⁷ are independently selected from: H, an alkyl group, halogen, —CN group, —NO₂ group, —O-alkyl group, an aryl group.
Aspect 2. The composition of any of the aspects, wherein the polymer has the following polymer backbone:

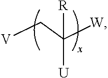

where R is an alkyl group or an H atom, x is 2 to 100,000, wherein U is a group that forms a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 3. The composition of any of the aspects, wherein the polymer is a block copolymer that has the following backbone:

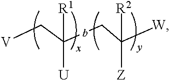

where R¹ is an alkyl group, x and y are independently 2 to 100,000, wherein U is a group that forms a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these, wherein Z and R² form a non-depolymerizable polymer block, wherein Z is a polystyrene group, a polyacrylate group, or a polyethylene group, wherein R² is an alkyl group or a hydrogen atom.
Aspect 4. The composition of any of the aspects, wherein the monomer unit is the methacrylate monomer unit.
Aspect 5. The composition of any of the aspects, wherein the methacrylate monomer unit is a methyl methacrylate monomer unit.
Aspect 6. The composition of any of the aspects, wherein the monomer unit is the styrenic monomer unit.
Aspect 7. The composition of any of the aspects, wherein the polymer is a homopolymer or a copolymer.
Aspect 8. The composition of any of the aspects, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 9. The composition of any of the aspects, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 10. The composition of any of the aspects, wherein the V and W are both present.
Aspect 11. A method of depolymerization of a polymer comprising: adding at least one of an α-chain end group (V) and/or an ω-chain end group (W) to the polymer to form a modified polymer, wherein V is selected from:

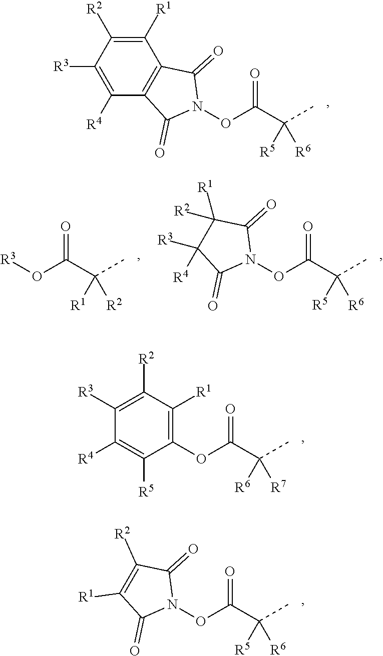

wherein W is selected from:

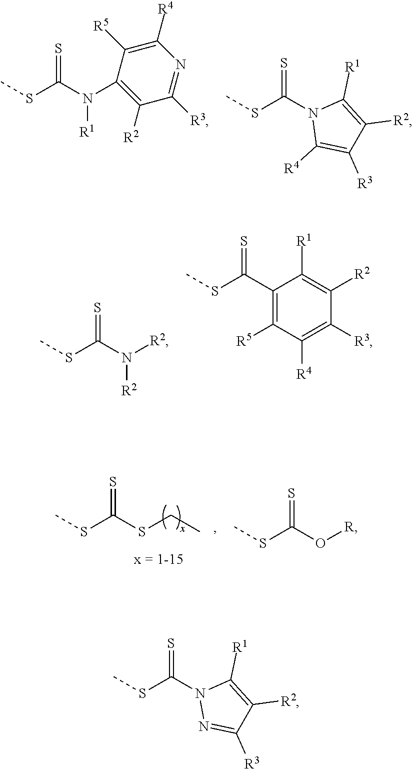

where the dashed line is the bond to the polymer, each of R, R¹, R², R³, R⁴, R⁵, R⁶, and R⁷ are independently selected from: H, an alkyl group, halogen, —CN group, —NO₂ group, —O-alkyl group, an aryl group, heating the modified polymer to about 180 to 300° C.; and depolymerization of the modified polymer, wherein about 90% of the monomer units are recovered.
Aspect 12. The method of any of the aspects, wherein a molecular weight of the polymer is about 1-10000 kg/mol.
Aspect 13. The method of any of the aspects, wherein the modified polymer is a homopolymer, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 14. The method of any of the aspects, wherein the modified polymer is a copolymer, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 15. The method of any of the aspects, wherein the monomer unit is the methacrylate monomer unit.
Aspect 16. The method of any of the aspects, wherein the methacrylate monomer unit is a methyl methacrylate monomer unit.
Aspect 17. The method of any of the aspects, wherein the monomer unit is the styrenic monomer unit.
Aspect 18. The method of any of the aspects, wherein the heating comprising heating the modified polymer to about 180 to 250° C.
Aspect 19. The method of any of the aspects, wherein the method is performed in a catalyst-free environment, a solvent-free environment, or both a catalyst-free environment and a solvent-free environment.
Aspect 20. A method of depolymerization a polymer comprising: heating the polymer to about 180 to 300° C., wherein the polymer is selected from the polymer described as described above or herein; and depolymerization of the modified polymer, wherein about 90% of the monomer units are recovered.
Aspect 21. The method of any of the aspects, wherein the polymer is a homopolymer, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 22. The method of any of the aspects, wherein the polymer is a copolymer, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.
Aspect 23. The method of any of the aspects, wherein the monomer unit is the methacrylate monomer unit.
Aspect 24. The method of any of the aspects, wherein the methacrylate monomer unit is a methyl methacrylate monomer unit.
Aspect 25. The method of any of the aspects, wherein the monomer unit is the styrenic monomer unit.
Aspect 26. The method of any of the aspects, wherein the heating comprising heating the modified polymer to about 180 to 250° C.
Aspect 27. The method of any of the aspects, wherein the method is performed in a catalyst-free environment, a solvent-free environment, or both a catalyst-free environment and a solvent-free environment.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### Example

We present the bulk depolymerization of poly(methyl methacrylate) (PMMA) at significantly lower temperatures than possible through currently available methods by the incorporation of thermolytically labile end-groups via reversible-deactivation radical polymerization (RDRP). The combination of α-end N-hydroxyphthalimide esters and ω-end trithiocarbonates allowed for near quantitative depolymerization of PMMA in the bulk, with >90% methyl methacrylate (MMA) recovered for subsequent repolymerization. This depolymerization methodology allows catalyst- and solvent-free reversion to monomer on a multigram scale at temperatures up to 250° C. lower than current industrial methods. These reactions are performed in an efficient and high-yielding manner, suggesting a viable route to depolymerize PMMA on large scales.

As the demand for plastics continues to rise, a concomitant increase in plastic waste has been observed.¹ In the United States, less than 10% of plastic waste is recycled; therefore, new recycling strategies have become imperative to reduce the negative impact on the environment.²⁻⁴ Current industrial efforts to recycle polymers are generally directed towards thermomechanical recycling, which typically yields lower-quality materials with reduced mechanical properties.^{1,5,6} Another promising means of recycling plastic waste involves chemical recycling, a method that can recycle or upcycle polymeric materials via chemical stimuli to degrade polymers to original or higher value materials.⁷ This method is particularly appealing since the recovered starting material can be re-polymerized to create a variety of polymeric materials with desired mechanical properties. Poly(ethylene terephthalate) (PET), for example, can be chemically recycled by hydrolysis, alcoholysis, or aminolysis of the backbone ester bond.^{8,9} The resulting compounds can then be reused to generate similar, if not identical, polymeric materials. In this case, chemical recycling methods of PET rely on the reactivity of ester functional groups within the polymer backbone.

Polymers synthesized by chain-growth polymerization of vinyl monomers are desirable due to the robustness imparted by their all-carbon backbones; however, the stability of carbon-carbon bonds renders the polymers exceptionally stable and difficult to revert to monomer, ultimately making chemical recycling prohibitively difficult. Methods to degrade vinyl-based polymers have centered around the incorporation of a monomer that introduces heteroatoms to facilitate degradation.¹⁰⁻¹⁴ This has been achieved through the radical ring-opening of cyclic acetals or thiolactones to incorporate degradable linkages in an otherwise all-carbon backbone.¹⁴⁻¹⁶ Other reports include the incorporation of monomers that are capable of generating backbone radicals to induce degradation through β-cleavage.¹⁷⁻²⁰ Recent methods have included the incorporation of a phthalimide methacrylate/acrylate monomer capable of accepting an electron from a photocatalyst, initiating a cascade reaction that liberates CO₂ to induce backbone degradation.^{20,21} While the aforementioned reports involve a side-chain trigger to efficiently cleave carbon-carbon backbone polymers, depolymerization from chain ends has arisen as an appealing approach to address the chemical recyclability of these all-carbon backbone polymers.²²

Poly(methyl methacrylate) (PMMA) is a polymer with an all-carbon backbone produced via chain-growth polymerization. PMMA is a commercial thermoplastic with wide applications as a glass substitute in aircraft, automotive, and construction industries. The production of PMMA currently resides at >4 million tons per year with usage expected to reach nearly 6 million tons by 2027.²³ The increase in industrial use of PMMA can be attributed to its high mechanical strength and low density compared to glass; however, less than 10% of PMMA is recycled annually.²³ Current methods for depolymerization of PMMA are achieved at high temperatures, ranging from 375-500° C., and the collected monomer is only achieved with purities between 78-85%. The quantity of MMA recovered is also highly dependent on depolymerization methodology.²⁴ To increase efficiency and monomer purity, high dilution can be used to reduce the ceiling temperature (T_{c}) of PMMA. This has been achieved by polymers synthesized through reversible-addition fragmentation chain transfer (RAFT) polymerization and atom transfer radical polymerization (ATRP). While RAFT polymerization and ATRP are normally used to synthesize polymers with controlled molecular weights, low dispersities, and well-defined architectures, recent reports have shown that activation of the chain ends inherent to these polymerization methods at elevated temperatures can trigger depolymerization.²⁵⁻³⁵

Initial reports by Gramlich and Ouchi demonstrated that the use of labile bonds on the chain ends of PMMA synthesized by RAFT polymerization and ATRP could be used to induce depolymerization through C—S cleavage or halide abstraction.^{36,37} More recently, Anastasaki demonstrated that terminal thiocarbonylthio chain ends could yield near-quantitative solution depolymerization under highly dilute conditions by exploiting chain-end C—S bond homolysis at temperatures as low as 120° C.³⁸ Our group demonstrated that depolymerization could be dramatically accelerated, at even lower temperatures (e.g., 100° C.), by increasing C—S bond cleavage via photolysis. We also established that the T_{c} of PMMA in dioxane at 5 mM of repeat units resides near 85° C.³⁹ Anastasaki also demonstrated that light could be used to accelerate depolymerization by utilizing an excess of eosin Y via a single electron transfer (SET) process to enhance the rate of terminal bond photolysis.⁴⁰ In another study, Matyjaszewski reported that polymethacrylate polymers synthesized via ATRP can also be depolymerized by leveraging the labile carbon-halogen bond on the polymer chain. Activation of the halogen chain end could be achieved with various copper halide salts, and more concentrated polymer solutions (0.7 M in monomer units) could be employed by increasing the temperature (>170° C.) to selectively distill monomer.⁴¹⁻⁴³ While the goal of increasing depolymerization efficiency of PMMA has been achieved, the requirements of high dilution and/or the necessity for catalysts may be prohibitory for widespread adoption of RDRP synthetic methodologies for enabling reversion to high-purity monomer. Block copolymer lithography, in addition to increasing material recyclability, is also an appealing potential application in which microphase-separated PMMA regions can be selectively depolymerized to achieve nanopatterned materials.⁴⁴

Reducing, or altogether removing, solvents and catalysts required to reduce the T_{c} of PMMA may further simplify industrial-scale and commercially relevant depolymerizations. Bulk thermal-initiated depolymerization of PMMA usually requires temperatures greater than 375° C. and produces a variety of undesirable byproducts that requires further purification of the resulting monomer. Herein, we demonstrate new synthetic approaches to generate PMMA amenable to efficient reversion to MMA by capitalizing on labile chain ends. This approach can be performed on the gram scale without catalyst or solvent. The depolymerization of PMMA prepared by these RDRP techniques can achieve up to 92% reversion to monomer at temperatures 250° C. lower than those currently applied on an industrial scale. Key to our approach is the selection of chain-end functional groups that generate terminal radicals above the boiling point of MMA, thus favoring reversion to monomer under non-equilibrium conditions.^{45,46}

### Results and Discussion

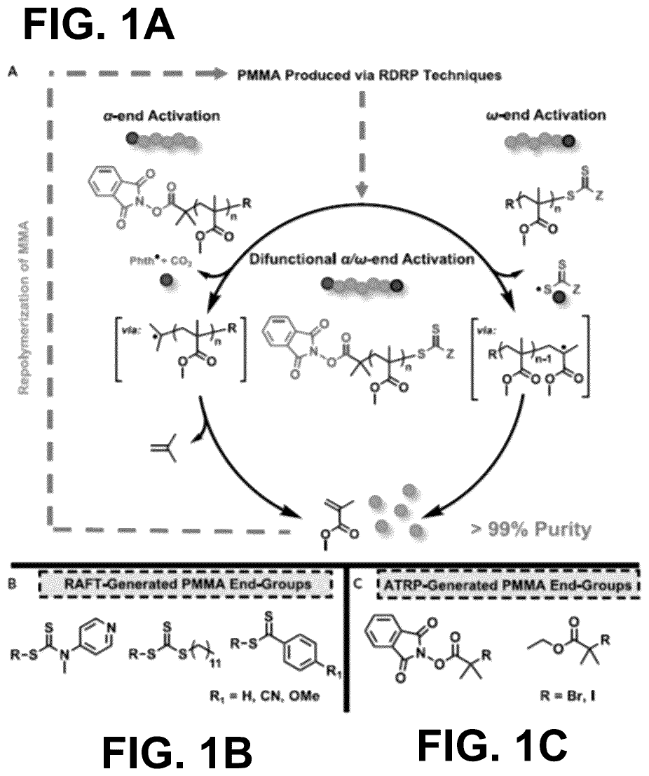

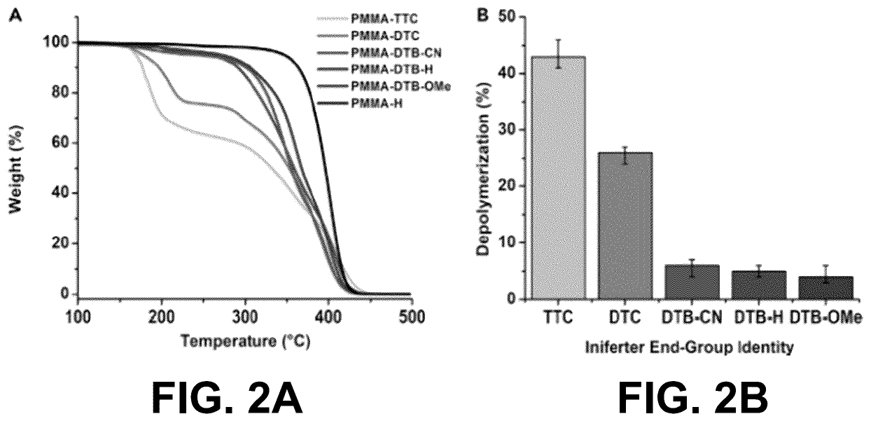

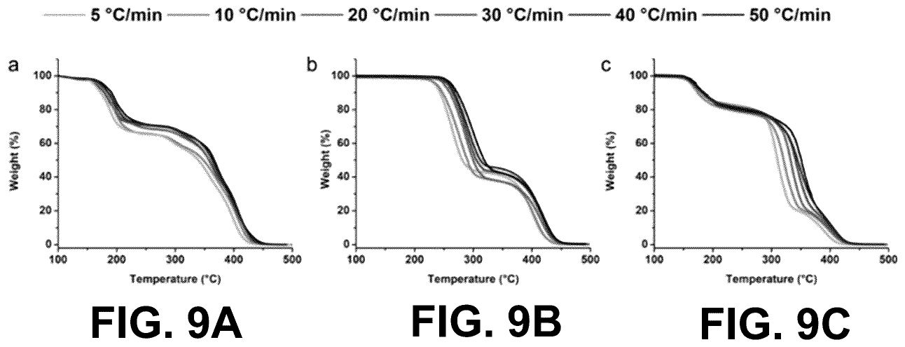

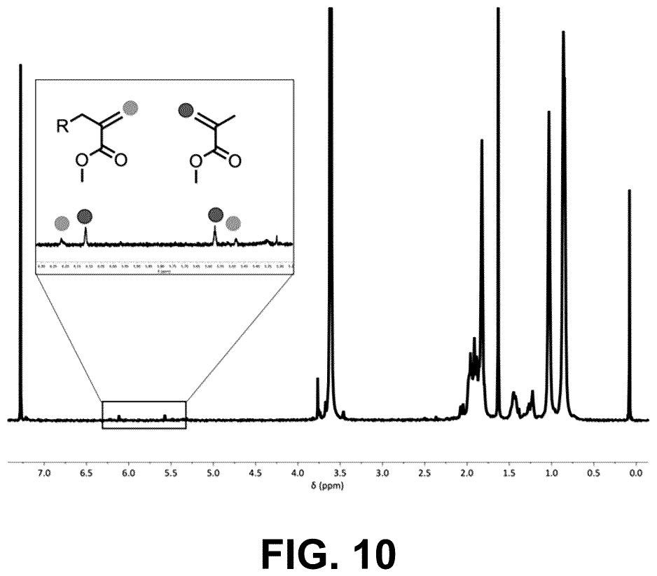

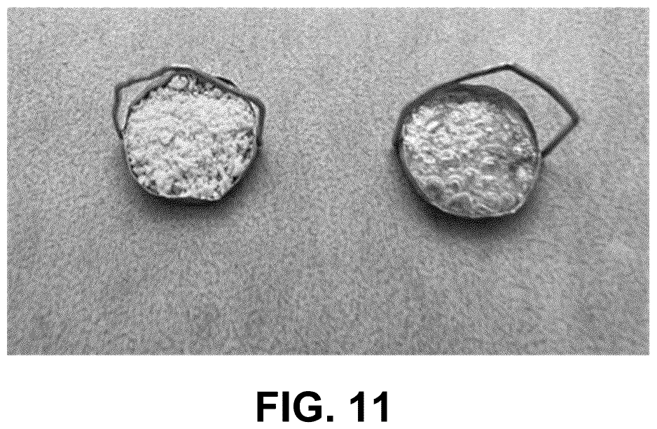

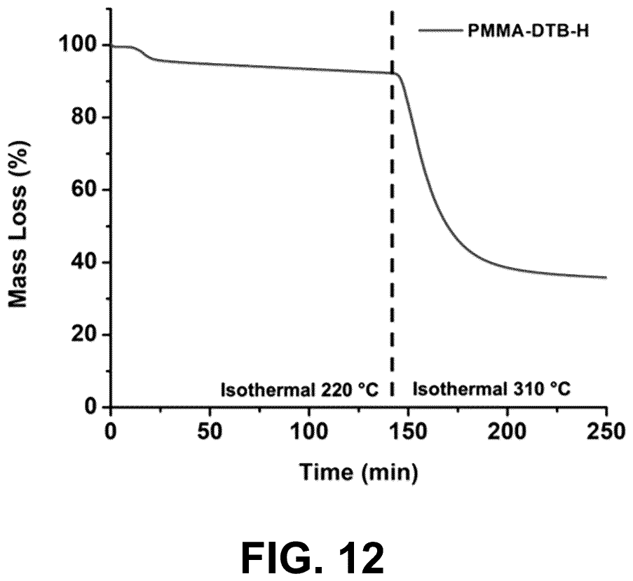

Our pursuit to find chain ends capable of achieving high degrees of depolymerization began by exploring various ω-end thiocarbonylthio functional groups on PMMA prepared via RAFT polymerization. Specifically, PMMA was prepared by RAFT polymerization with 2-cyanoprop-2-yl dithiobenzoate (PMMA-DTB-H, 6.1 kg/mol), 2-cyanopropyl-2-yl(4-methoxy) dithiobenzoate (PMMA-DTB-OMe, 5.9 kg/mol), 2-cyanopropyl-2-yl(4-cyano) dithiobenzoate (PMMA-DTB-CN, 5.5 kg/mol), 2-cyanopropan-2-yl N-methyl-N-(pyridin-4-yl)carbamodithioate (PMMA-DTC, 8.1 kg/mol), and 4-cyano-4-[(dodecylsulfanylthiocarbonyl) sulfanyl]pentanoic acid (PMMA-TTC, 5.3 kg/mol) (FIGS. 1B and 2). Molecular weights were maintained within +-1.5 kg/mol to reduce the effects of chain length on the extent of depolymerization. The thermal stability of the RAFT polymer end-groups was then investigated via thermogravimetric analysis (TGA) to determine the onset temperature of depolymerization, which we defined as the temperature at which 95% of the mass remains (T₉₅) (Table S1). While the temperature for the onset of depolymerization depended on heating rate, lower ramp rates of 5-10° C./min were found to have the most repeatable onset temperatures of depolymerization (FIG. 9). It was observed that the T₉₅ for functionalized PMMA ranged from 148° C. for PMMA-TTC to 186° C. for PMMA-DTB-OMe. PMMA without the RAFT-derived end-groups (PMMA-H) was considerably more stable and did not degrade until temperatures near 376° C. (Table S1). Notably, the highest extent of depolymerization was observed with the PMMA-TTC, which reached 42% mass loss until a plateau was observed in the TGA trace. In contrast, the PMMA-DTC achieved 28% depolymerization while the dithiobenzoyl-terminated polymers (PMMA-DTB-H, —CN, —OMe) only reached 4-7% depolymerization before an observed plateau in the TGA trace (FIG. 2). When investigating the reduced extent of depolymerization for the PMMA-DTB samples, ¹H NMR spectroscopy provided evidence of a predominant side reaction that competed with depolymerization. The major byproducts after thermal treatment were determined to be alkene-terminated PMMA, attributed to the Chugaev-elimination pathway that can occur with thiocarbonylthio functional groups at elevated temperatures (FIGS. 10 and 11).⁴⁷⁻⁵⁰ Interestingly, this terminal alkene group enabled a second onset of depolymerization to occur near 310° C. (FIG. 12). These results agree with previous TGA data reported by Kudryavtsev et al. in which trithiocarbonate-terminated PMMA also demonstrated a higher degree of depolymerization relative to DTB-terminated PMMA.⁵¹

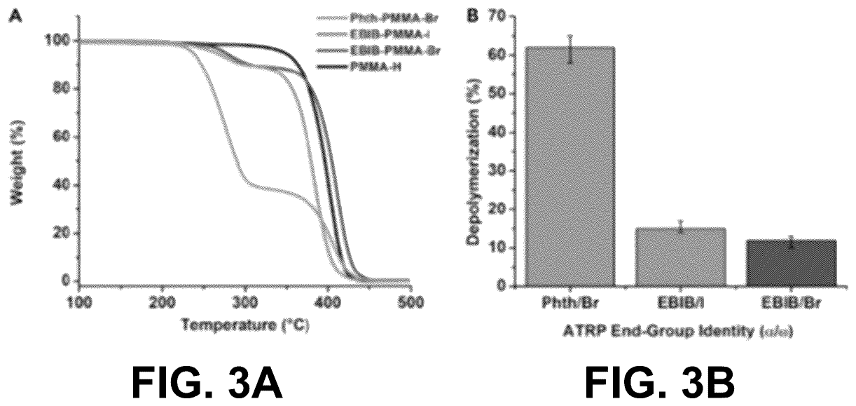

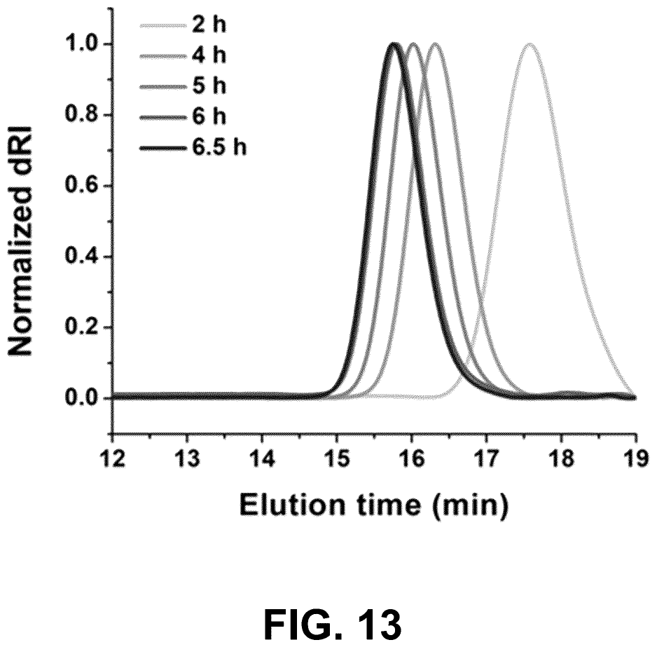

In addition to RAFT polymerization, ATRP is one of the most widely used RDRP techniques and generally leads to polymers that are white or colorless, a potential advantage over the yellow- or pink-colored thiocarbonylthio moieties that remain in RAFT-generated polymers.⁵²⁻⁵⁵ A variety of ATRP-derived chain ends were explored to examine the thermolytic capacity for depolymerization (FIG. 1C). Ethyl a-bromo isobutyrate (EBIB), a commonly used ATRP-initiator, was used to polymerize MMA by supplemental activator and reducing agent (SARA) ATRP.⁵⁶ Thermal treatment of the synthesized PMMA-Br exhibited an onset of depolymerization at 285° C., but only ˜12% depolymerization was observed (FIG. 3). PMMA-Br subsequently underwent treatment with sodium iodide via the Finkelstein reaction to substitute the terminal bromine with iodine. While a lower onset temperature of depolymerization was observed at 272° C., the extent of depolymerization was only slightly increased to 14%. Due to the lack of efficient depolymerization achieved through thermolysis of the ω-halogen chain ends, we turned our attention to synthesizing PMMA with labile bonds on their α-chain ends. This was achieved by preparing an ATRP initiator containing an N-hydroxy phthalimide ester (Phth). Subsequent polymerization of MMA by SARA ATRP provided the desired polymer (Phth-PMMA-Br) with controlled molecular weight and low dispersity (FIG. 13). Analysis of the Phth-PMMA-Br by TGA showed up to 65% depolymerization, with the T₉₅ occurring near 220° C. (Table S1). Unlike the other ATRP-derived polymers, depolymerization can be primarily attributed to thermolysis stemming from decarboxylation of the Phth-esters and subsequent loss of isobutylene from the α-chain end of PMMA (FIGS. 1A and 3).

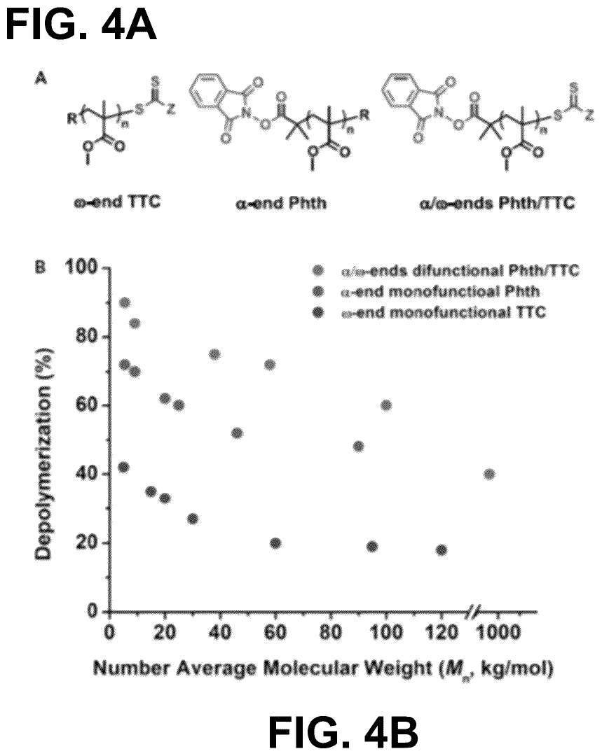

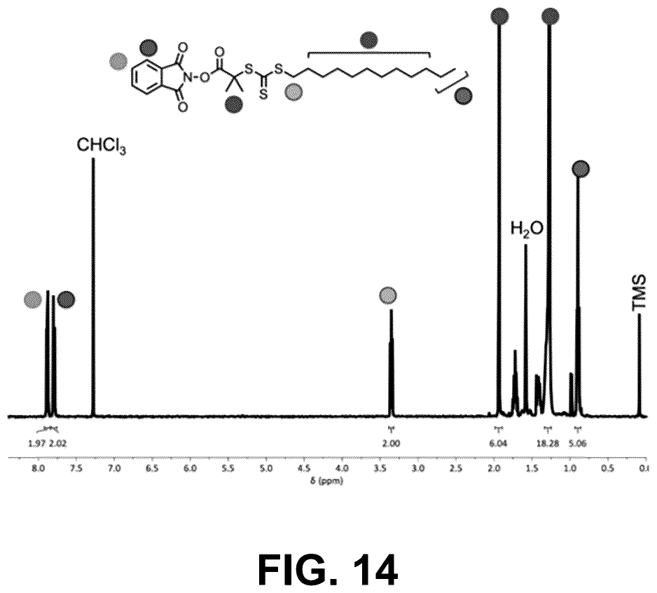

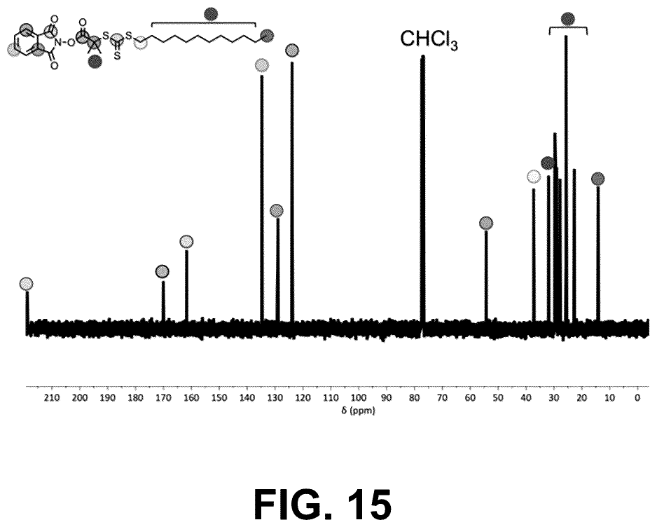

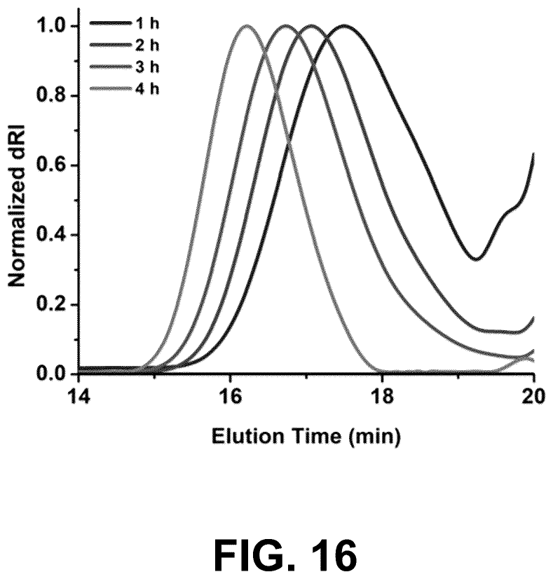

Given the successful depolymerization attributed to the Phth and TTC end-groups, we prepared a Phth-functional RAFT agent to access polymers that contained thermally labile moieties on both chain ends. We reasoned that more efficient depolymerization may be enabled by the higher concentration of thermally sensitive end-groups. A thiocarbonylthio compound (i.e., 1,3-dioxoisoindolin-2-yl 2-(((dodecylthio)carbonothioyl)thio)-2-methylpropanoate) (Phth-TTC) was prepared by esterifying 2-(dodecylthiocarbonothioylthio)-2-methylpropionic acid (DDMAT) with N-hydroxyphthalimide (FIGS. 14 and 15). The resulting Phth-TTC was subsequently used to polymerize MMA via photoiniferter polymerization, a polymerization method that enables high retention of the thiocarbonylthio moiety during polymerization to produce (Phth-PMMA-TTC, 5.4 kg/mol, Ð=1.13) (FIG. 4A).⁵⁷⁻⁶³ Interestingly, unlike the trithiocarbonate precursor in which the R-group is generally not ideal for polymerization of methacrylate monomers (i.e., resulting in high dispersities and poor molecular weight control), the Phth-TTC provided a well-controlled polymerization (FIG. 16). We attribute this to the electron-withdrawing nature of the Phth moiety facilitating more efficient β-cleavage of the R-group.^{33,64} Gratifyingly, the combination of both chain ends in Phth-PMMA-TTC resulted in a much higher final extent of depolymerization (92%) compared to 42% for PMMA-TTC or 65% for Phth-PMMA-Br (Table Si). These data suggest that polymers capable of α- and ω-initiated depolymerization offer a promising route toward enhancing the efficiency of bulk depolymerizations.

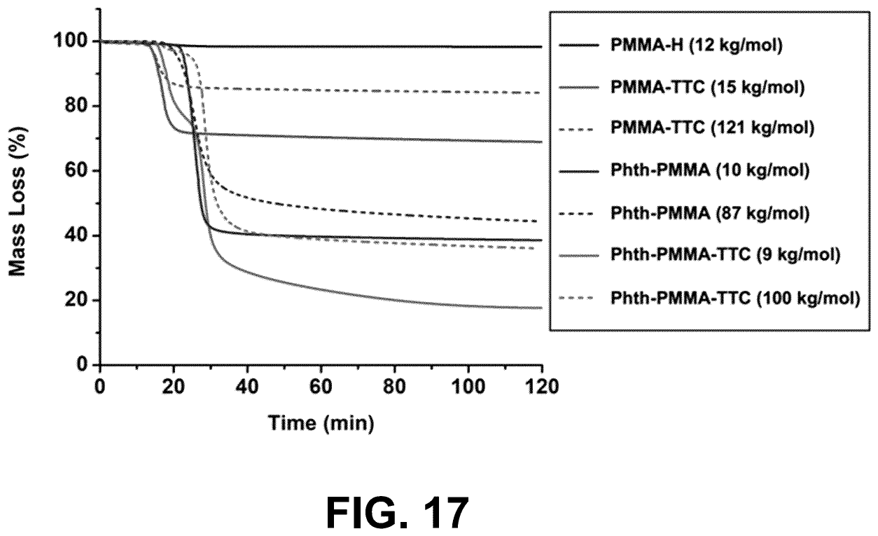

We then examined the effect of molecular weight on the final extent of depolymerization (FIGS. 4A and 4B and Table S1). PMMA-TTC, Phth-PMMA, and Phth-PMMA-TTC polymers were prepared, ranging in molecular weight from 5.0 to 980 kg/mol. All of the polymers were subjected to a ramp rate of 10° C./min over a temperature range of 20-500° C. The extent of depolymerization was calculated by TGA as the mass loss observed up to the plateau region prior to the degradation temperature at 376° C. In addition to this method, the extent of depolymerization could also be calculated by subjecting polymer samples to an isothermal hold at 220° C. for 2 h (FIG. 17). The values determined by these two methods differed by less than 4%. The extent of depolymerization for low molecular weight PMMA-TTC reached up to 43%; however, polymer samples with higher molecular weights near 100 kg/mol achieved only 20% depolymerization. The Phth-PMMA polymers exhibited a similar trend in which low molecular weight polymers could achieve up to 65% depolymerization, but higher molecular weight polymers approaching 100 kg/mol achieved only 48% depolymerization. As mentioned previously, the combination of both chain ends in Phth-PMMA-TTC polymers resulted in the highest degrees of depolymerization. The Phth-PMMA-TTC polymers demonstrated a similar trend in which low molecular weight polymers could achieve up to 92% depolymerization, but higher molecular weight polymers approaching 100 kg/mol achieved only 62% depolymerization. To further probe the limitations of depolymerizing high molecular weight polymers, we employed photoiniferter polymerization to achieve ultrahigh molecular weight (UHMW) polymers, a class of materials that have garnered particular recent interest.⁶⁵⁻⁶⁷ As such, a 980 kg/mol Phth-PMMA-TTC was synthesized, and 41% depolymerization was observed. These results suggest that the extent of depolymerization decreases with molecular weight, which is consistent with the results from depolymerization under highly dilute conditions (FIG. 17).⁶⁸

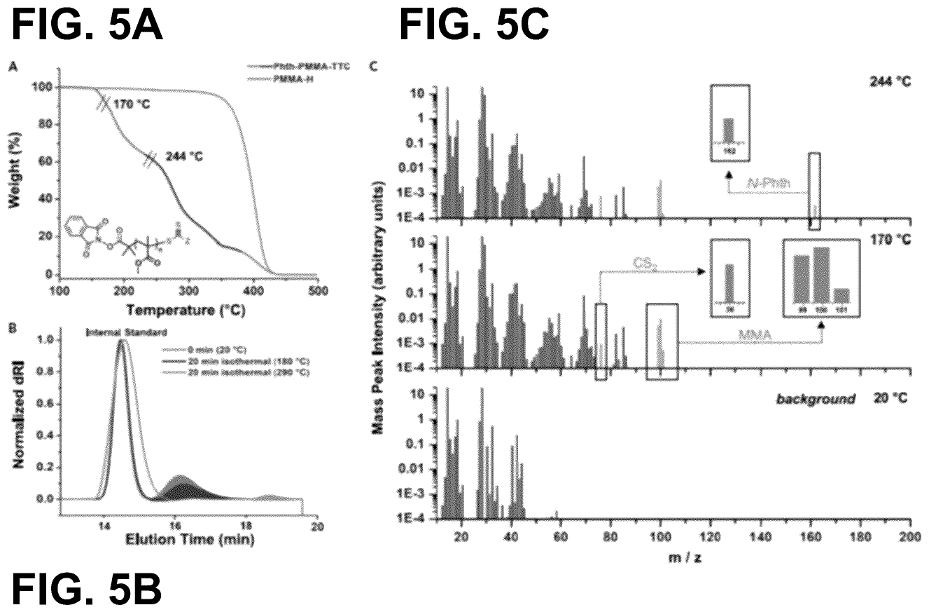

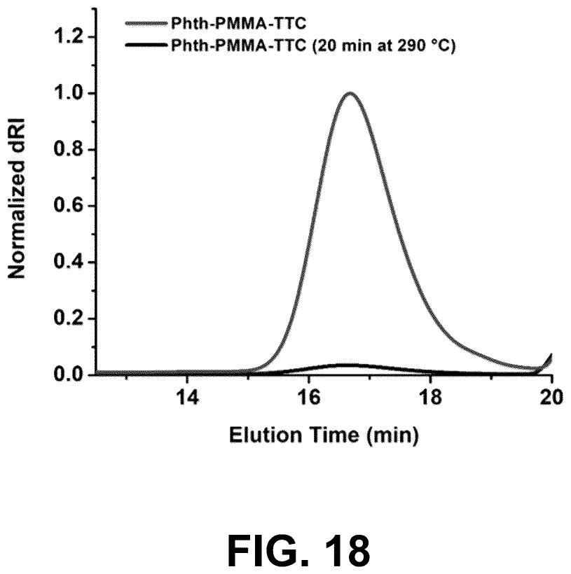

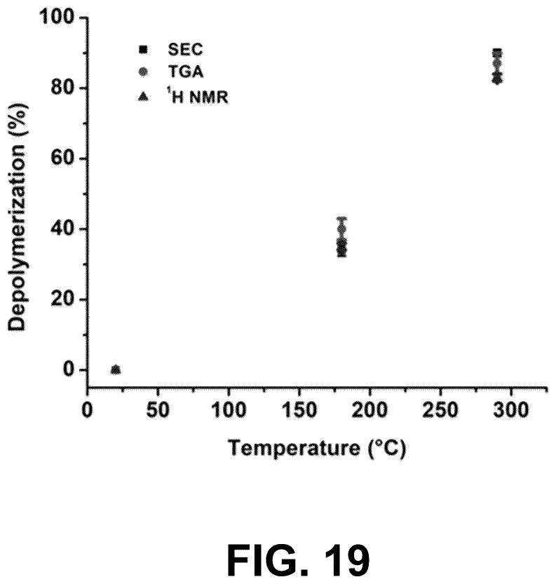

TGA analysis of the difunctional polymer indicated there were two separate onsets of depolymerization, the first at 150° C. attributed to initiation from the ω-end TTC and the second at 220° C. from the α-end Phth (FIG. 5A, Table Si). Evidence for two separate mechanisms of chain-end-initiated depolymerization was further supported by the results of two separate, parallel isothermal holds, one at 180° C. and the other 290° C. for 20 min each. Analysis of the quantity of depolymerization via size-exclusion chromatography (SEC) indicated a mass loss of roughly 40%, which we attribute to depolymerization from the ω-end initiated by C—S thermolysis (FIG. 5B). The isothermal hold at 290° C. resulted in 92% mass loss, 40% attributed to depolymerization from the ω-end TTC and an additional 52% which we attribute to depolymerization induced by cleavage of the α-end Phth group (FIG. 5B). The final polymer byproduct was observed as a polymer of the same molecular weight as the starting polymer (FIGS. 5B and 18). All methods in the determination of the extent of depolymerization were in good agreement and differed no more than 5% between SEC analysis, TGA analysis, and ¹H NMR analysis (FIG. 19).

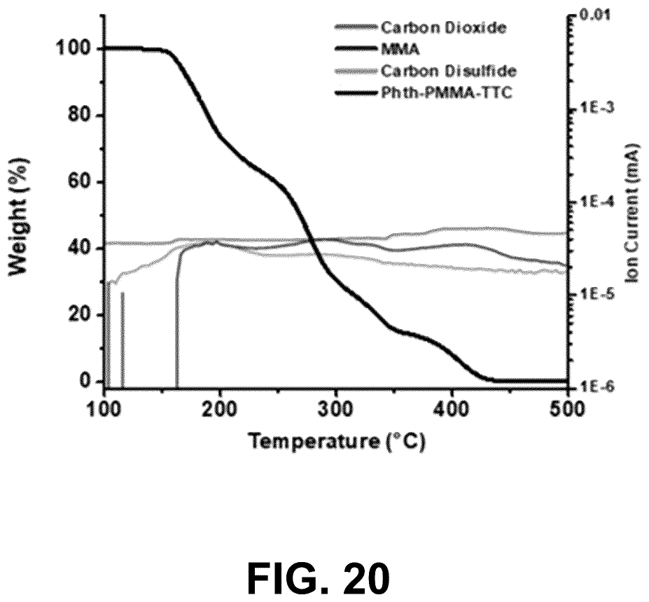

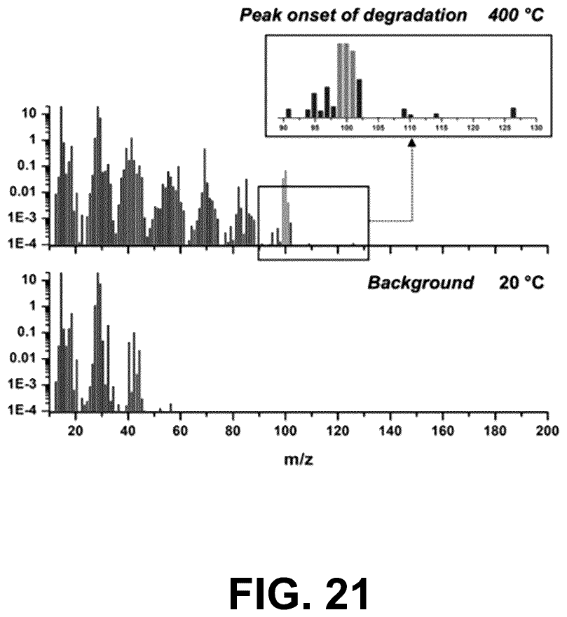

TGA-tandem mass spectrometry (TGA-MS) provided valuable insight into the mechanism of chain-end-initiated depolymerization by allowing analysis of the products liberated during thermal treatment (FIG. 5C). Most importantly, throughout depolymerization the major product observed corresponded to that of the isotopes of MMA monomer (FIG. 5C, Table S2). The generated byproducts helped to confirm our hypothesis that two separate onsets of depolymerization occur for the difunctional Phth-PMMA-TTC. For example, when Phth-PMMA-TTC was heated from 20° C. to 500° C. at a rate of 10° C./min, an ion fragment at 76 g/mol, indicating the release of CS₂, was detected at 170° C. This result suggests that higher temperatures near 170° C. promote C—S homolysis to a PMMA radical which readily depolymerizes and a TTC radical adduct that degrades to CS₂ and dodecane thiol.^{69,70} Furthermore, at 244° C. ion fragments of 162 g/mol (Phth) were observed, which suggests cleavage from the α-chain end. A subsequent increase in MMA generation was observed indicating a second onset of depolymerization. From previous work, we hypothesize that the Phth group undergoes a decarboxylative degradation pathway with subsequent release of an isobutylene unit to generate a tertiary methacroyl radical capable of initiating depolymerization (FIG. 1). Tracking ion fragments corresponding to CO₂ showed an increase in intensity at the second onset of depolymerization, corresponding to decarboxylation of the Phth-ester (FIG. 20). During both onsets of depolymerization, no MMA byproduct or dimer was observed. In contrast, unfunctionalized PMMA-H was found to require significantly higher temperatures to induce depolymerization (>376° C.) as determined by TGA-MS. Degrading PMMA-H at 400° C. led to ion fragments that correspond to MMA, but numerous byproducts were also present (FIG. 21, Table S2). A significant mass peak at 102 g/mol corresponding to methyl pyruvate was observed, indicating that depolymerization initiated at higher temperatures generates undesired byproducts. Other masses at 90-99, 102-114, and 126 g/mol were also observed as distinct byproducts that were not present in TGA-MS spectra for functionalized PMMA samples (Table S2). Similar results have been shown by Marcantoni et al. in which unfunctionalized PMMA was degraded to monomer and as many as 6 other contaminant byproducts.²⁴ These six contaminant byproducts were not detected via ¹H NMR analysis of the recovered monomer from PMMA-TTC, Phth-PMMA, or Phth-PMMA-TTC samples.

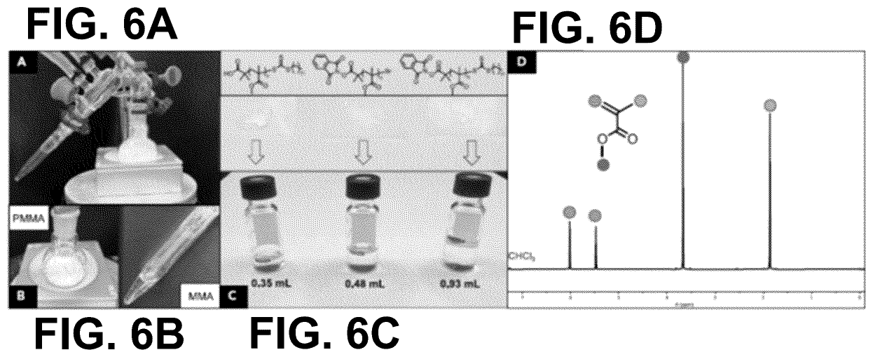

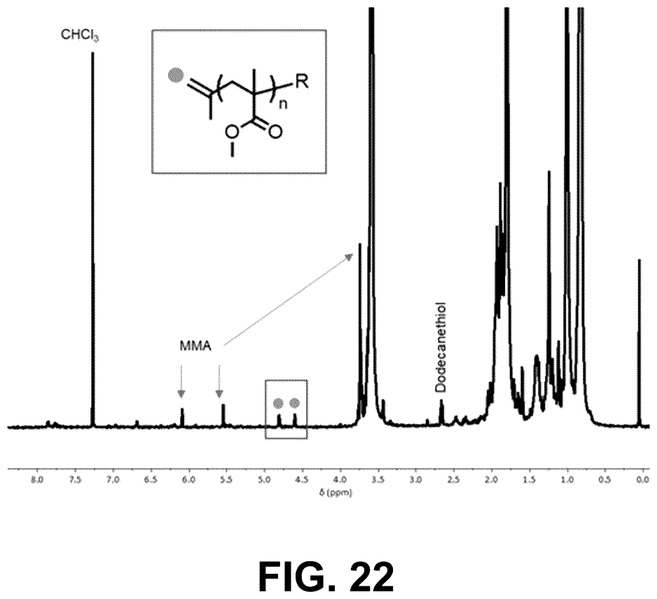

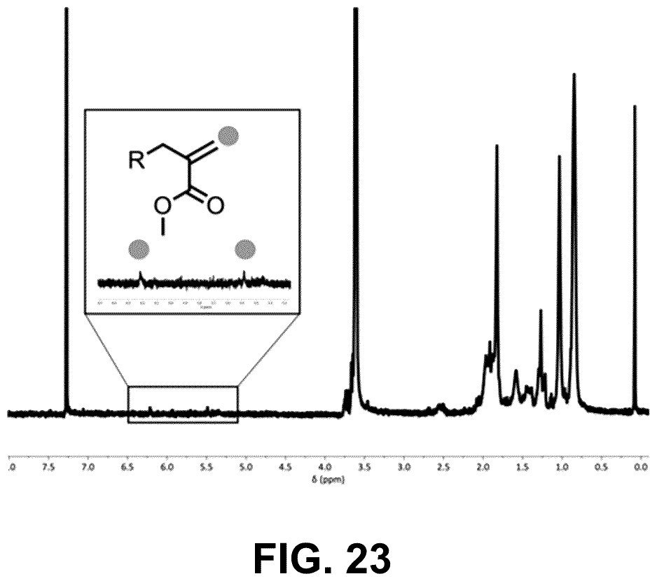

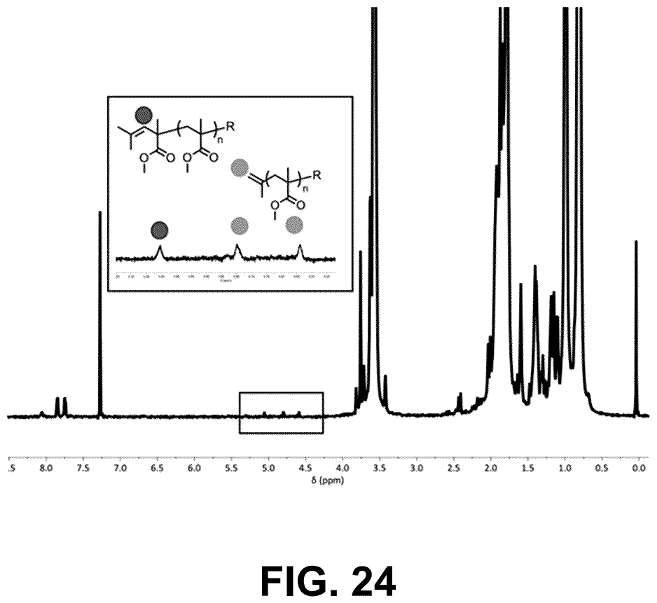

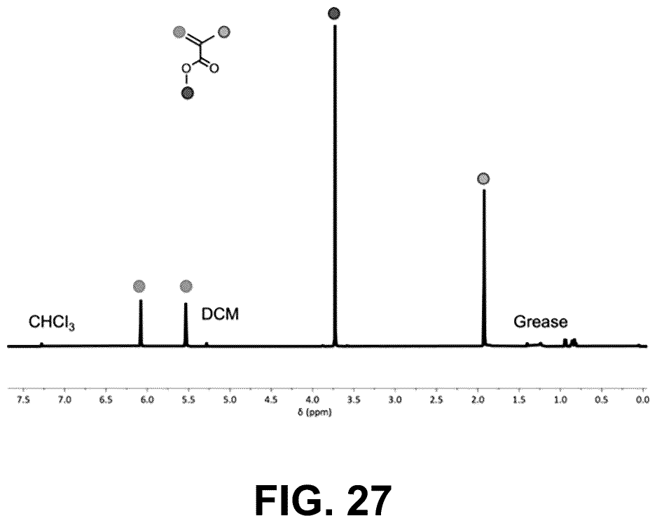

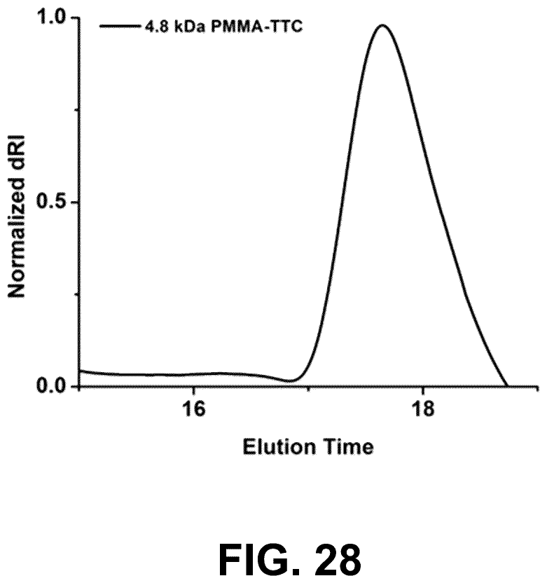

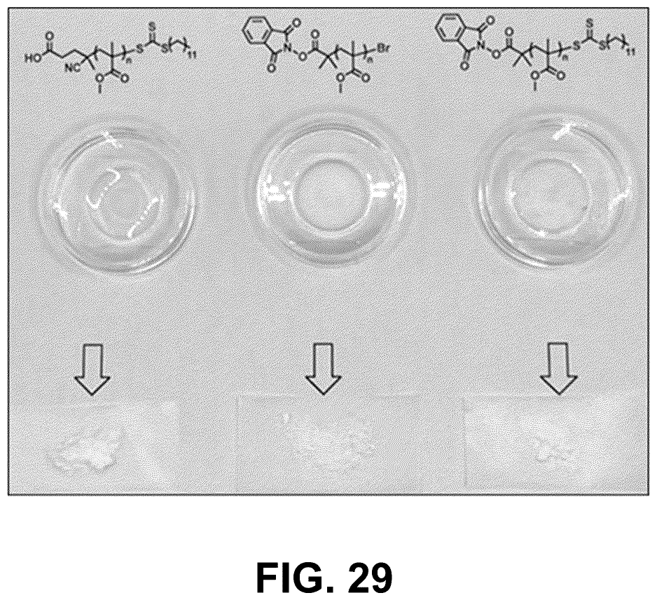

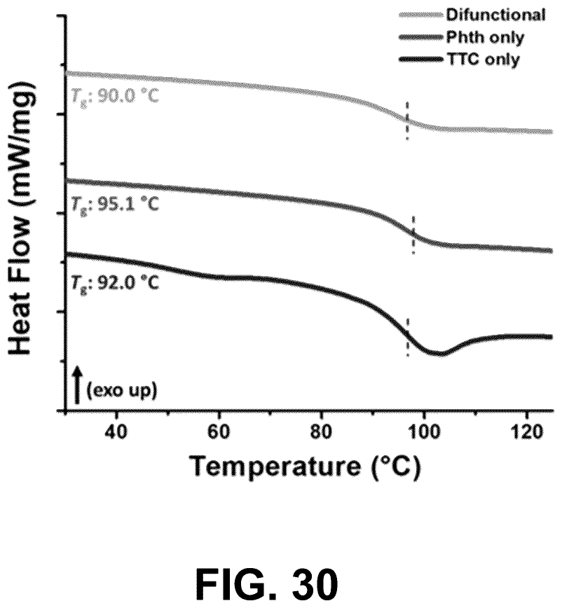

To demonstrate the viability of this PMMA depolymerization methodology for monomer recovery, we explored the bulk depolymerization of gram-scale quantities of PMMA-TTC (5.5 kg/mol), Phth-PMMA-Br (5 kg/mol), and Phth-PMMA-TTC (5.4 kg/mol) (FIG. 6A). The bulk polymers were heated to 210-220° C. and held for 1 h under vacuum to maximize monomer recovery (FIG. 6B). Theoretical yields were determined by comparing the mass of the recovered monomer to the maximum mass loss during depolymerization observed by TGA. As expected, the monofunctional PMMA-TTC yielded the lowest reversion to monomer (43% mass loss, 94% theoretical yield, 0.35 mL MMA recovered). In comparison, Phth-PMMA-Br demonstrated modest monomer recovery (62% mass loss, 87% theoretical yield, 0.48 mL MMA recovered) (FIG. 6C). Lastly, the difunctional Phth-PMMA-TTC yielded the highest reversion to monomer (92% mass loss, 88% theoretical yield, 0.93 mL MMA recovered). The remaining polymer products also contained byproducts from end-group degradation, such as phthalimide products and dodecanethiol, indicating that thermolytically active chain ends underwent thermolysis to initiate depolymerization but were not distilled with the generated MMA (FIG. 22). Terminal alkene peaks were observed in the Phth-PMMA and Phth-PMMA-TTC byproducts, in addition to the PMMA-TTC Chugaev elimination product, suggesting that disproportionation occurs on the α-end as well (FIGS. 22-24). Regardless, the resulting monomer from all bulk depolymerizations had high degrees of purity (FIGS. 6D, 26, 27). In all three cases, monomer could be repolymerized to polymer without further purification (FIG. 28). While the telechelic Phth-PMMA-TTC material exhibited the highest monomer recovery, it is important to note that the Phth-PMMA may have the broadest utility, as the material is colorless and transparent (FIG. 6C). Solvent-cast films of the low molecular weight Phth-PMMA also demonstrated a high degree of transparency and lack of color relative to the TTC-containing materials (FIG. 29), suggesting these polymers may be useful for applications where colorless materials are desired. Furthermore, differential scanning calorimetry (DSC) analysis showed that the end-functional polymers had similar T_{g}'s to that of unfunctionalized PMMA (FIG. 30).

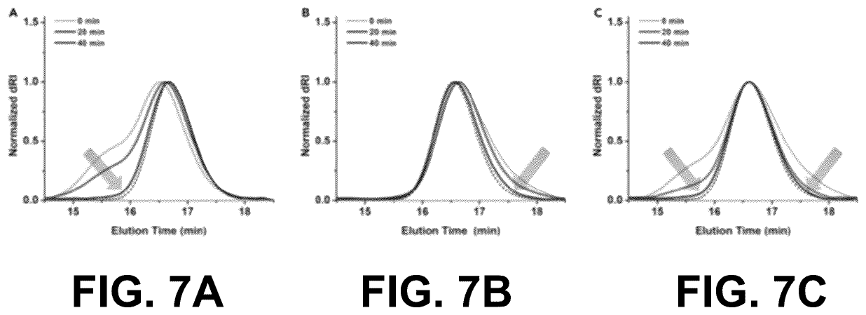

The shape and width of polymer molecular weight distributions (MWD) have significant implications on material properties of the polymers such as processability and mechanical strength.^{71,72} While many recent reports have focused on tailoring initiation or using flow-mediated strategies to tune the MWD, the most widely used method to achieve different MWDs is through the physical blending of different polymers.⁷³⁻⁷⁸ We hypothesized that by blending polymers with activatable chain ends (Phth-PMMA-TTC) and those without activatable chain ends (PMMA-H), the MWD could be further tuned through selective depolymerization. MWD tuning was achieved through the skew customization by unzipping layered polymer traces (SCULPT) method. As such, we examined how a set of three different polymers could be used to selectively skew the number-average molecular weight (Mₙ) towards a lower Mₙ, higher Mₙ, and inward towards a central Mₙ distribution. Two difunctional polymers (Phth-PMMA-TTC, 5.4 kg/mol, Ð=1.13, 19.8 kg/mol, Ð=1.30) were blended with an unfunctionalized polymer (PMMA-H, 12.0 kg/mol, Ð=1.01) in various quantities to achieve mixed polymer distributions (FIG. 7). Timepoints were taken at 0, 20, and 40 min to observe the suppression of the polymer trace associated with Phth-PMMA-TTC by SEC. In examining the ability to skew towards a low Mₙ distribution, a 1:1 weight mixture of functionalized Phth-PMMA-TTC (19.8 kg/mol, Ð=1.30) and unfunctionalized PMMA-H (12.0 kg/mol, Ð=1.01) was prepared to yield a final polymer blend with a broadened MWD (14.7, kg/mol, Ð=1.18). An isothermal hold of the polymer blend at 290° C. resulted in depolymerization of the Phth-PMMA-TTC to yield a final monomodal polymer distribution (11.8, kg/mol, Ð=1.05) that closely resembled that of the initial PMMA-H trace (FIG. 7A). To analyze the possibility to skew towards a higher Mₙ, a 1:1 weight mixture of the Phth-PMMA-TTC (5.4 kg/mol, Ð=1.13) and PMMA-H (12 kg/mol, Ð=1.01) was prepared yielding a final polymer blend with a broadened MWD (7.34 kg/mol, Ð=1.32). In this case, an isothermal hold at 290° C. resulted in near-quantitative disappearance of the low Mₙ difunctional Phth-PMMA-TTC to yield a final monomodal polymer distribution with a higher Mₙ (11.1 kg/mol, Ð=1.06) (FIG. 7B). Finally, to demonstrate the ability to skew towards a central Mₙ distribution through the SCULPT method, a blend containing 1:1:1 of both difunctional (5.5 kg/mol, Ð=1.13 and 19.8 kg/mol, Ð=1.30) and the unfunctionalized PMMA-H (12 kg/mol, Ð=1.01) was prepared yielding a final polymer blend with a broadened MWD (8.3 kg/mol, Ð=1.46). A final narrowed monomodal distribution (11.3 kg/mol, Ð=1.07) was achieved after an isothermal hold at 290° C., demonstrating the viability to selectively depolymerize both high- and low-molecular-weight chains while retaining a pre-determined, unfunctionalized central distribution (FIG. 7C). In all three instances, depolymerization of the functionalized peak shoulders yielded nearly identical polymer traces to that of the unfunctionalized PMMA-H.

### CONCLUSION

The use of thermally labile chain ends for the bulk depolymerization of PMMA could facilitate the translation of PMMA synthesized by RDRP methods to industry by closing the life-cycle circularity of polymeric materials. Our work demonstrates that RDRP-generated polymers are capable of undergoing thermally-initiated depropagation at onset temperatures significantly lower than unfunctionalized PMMA. The ω-end trithiocarbonate and α-end phthalimide polymers resulted in the greatest extent of depolymerization at 42 and 65%, respectively. By utilizing a difunctional photoiniferter, we installed both the trithiocarbonate and phthalimide chain ends on PMMA to achieve even higher degrees of depolymerization of 92%. Both end-groups facilitated reversion to monomer on the gram scale at 190-250° C. lower than that required for unfunctionalized PMMA. We then examined the effect of molecular weight on the final extent of depolymerization and showed that even UHMW difunctional PMMA can achieve up to 41% depolymerization, setting a precedent for the ability to depolymerize a vast array of molecular weights. TGA-MS enabled observation of the ion fragments that correspond to the byproducts of chain-end cleavage, offering insight into mechanisms involving chain-end-initiated depolymerization. Furthermore, high-purity monomer was recovered and repolymerized without further purification. Lastly, our SCULPT process demonstrates that blended polymers can be selectively depolymerized to skew MWD, providing promise for end-of-life tuning of physical properties and monomer recovery in mixed polymer systems.

### REFERENCES

1. Schyns, Z. O. G., and Shaver, M. P. (2021). Mechanical Recycling of Packaging Plastics: A Review. Macromol. Rapid Commun. 42, 1-27. 10.1002/marc.202000415.
2. Rahimi, A. R., and Garcia, J. M. (2017). Chemical recycling of waste plastics for new materials production. Nat. Rev. Chem. 1, 1-11. 10.1038/s41570-017-0046.
3. Kim, D., Hinton, Z. R., Bai, P., Korley, L. S. T. J., Epps, T. H., and Lobo, R. F. (2022). Metathesis, molecular redistribution of alkanes, and the chemical upgrading of low-density polyethylene. Appl. Catal., B 318, 121873. 10.1016/j.apcatb.2022.121873.
4. Saxon, D. J., Luke, A. M., Sajjad, H., Tolman, W. B., and Reineke, T. M. (2020). Next-generation polymers: Isosorbide as a renewable alternative. Prog. Polym. Sci. 101, 101196. 10.1016/j.progpolymsci.2019.101196.
5. Ragaert, K., Delva, L., and Van Geem, K. (2017). Mechanical and chemical recycling of solid plastic waste. Waste Manage. 69, 24-58. 10.1016/j.wasman.2017.07.044.
6. Hinton, Z. R., Talley, M. R., Kots, P. A., Le, A. V., Zhang, T., MacKay, M. E., Kunjapur, A. M., Bai, P., Vlachos, D. G., Watson, M. P., et al. (2022). Innovations Toward the Valorization of Plastics Waste. Annu. Rev. Mater. Res. 52, 249-280. 10.1146/annurev-matsci-081320-032344.
7. Worch, J. C., and Dove, A. P. (2020). 100th Anniversary of Macromolecular Science Viewpoint: Toward Catalytic Chemical Recycling of Waste (and Future) Plastics. ACS Macro Lett. 9, 1494-1506. 10.1021/acsmacrolett.0c00582.
8. Jehanno, C., Perez-Madrigal, M. M., Demarteau, J., Sardon, H., and Dove, A. P. (2019). Organocatalysis for depolymerisation. Polym. Chem. 10, 172-186. 10.1039/c8py01284a.
a9. Jehanno, C., Alty, J. W., Roosen, M., De Meester, S., Dove, A. P., Chen, E. Y. X., Leibfarth, F. A., and Sardon, H. (2022). Critical advances and future opportunities in upcycling commodity polymers. Nature 603, 803-814. 10.1038/s41586-021-04350-0.
10. Shieh, P., Zhang, W., Husted, K. E. L., Kristufek, S. L., Xiong, B., Lundberg, D. J., Lem, J., Veysset, D., Sun, Y, Nelson, K. A., et al. (2020). Cleavable comonomers enable degradable, recyclable thermoset plastics. Nature 583, 542-547. 10.1038/s41586-020-2495-2.
11. Kamiki, R., Kubo, T., and Satoh, K. (2023). Addition-Fragmentation Ring-Opening Polymerization of Bio-Based Thiocarbonyl 1-Lactide for Dual Degradable Vinyl Copolymers. Macromol. Rapid Commun. 44, 1-6. 10.1002/marc.202200537.
12. Wang, W., Zhou, Z., Sathe, D., Tang, X., Moran, S., Jin, J., Haeffner, F., Wang, J., and Niu, J. (2022). Degradable Vinyl Random Copolymers via Photocontrolled Radical Ring-Opening Cascade Copolymerization**. Angew. Chem. Int. Ed. 134, 1-9. 10.1002/ange.202113302.
13. Huang, B., Wei, M., Vargo, E., Qian, Y, Xu, T., and Toste, F. D. (2021). Backbone-Photodegradable Polymers by Incorporating Acylsilane Monomers via Ring-Opening Metathesis Polymerization. J. Am. Chem. Soc. 143, 17920-17925. 10.1021/jacs.1c06836.
14. Hill, M. R., Guegain, E., Tran, J., Figg, C. A., Turner, A. C., Nicolas, J., and Sumerlin, B. S. (2017). Radical Ring-Opening Copolymerization of Cyclic Ketene Acetals and Maleimides Affords Homogeneous Incorporation of Degradable Units. ACS Macro Lett. 6, 1071-1077. 10.1021/acsmacrolett.7b00572.
15. Smith, R. A., Fu, G., McAteer, O., Xu, M., and Gutekunst, W. R. (2019). Radical Approach to Thioester-Containing Polymers. J. Am. Chem. Soc. 141, 1446-1451. 10.1021/jacs.8b12154.
16. Spick, M. P., Bingham, N. M., Li, Y, De Jesus, J., Costa, C., Bailey, M. J., and Roth, P. J. (2020). Fully Degradable Thioester-Functional Homo- And Alternating Copolymers Prepared through Thiocarbonyl Addition-Ring-Opening RAFT Radical Polymerization. Macromolecules 53, 539-547. 10.1021/acs.macromol.9b02497.
17. Kimura, T., Kuroda, K., Kubota, H., and Ouchi, M. (2021). Metal-Catalyzed Switching Degradation of Vinyl Polymers via Introduction of an “in-Chain” Carbon-Halogen Bond as the Trigger. ACS Macro Lett. 10, 1535-1539. 10.1021/acsmacrolett.1c00601.
a18. Makino, H., Nishikawa, T., and Ouchi, M. (2022). Incorporation of a boryl pendant as the trigger in a methacrylate polymer for backbone degradation. ChemComm 58, 11957-11960. 10.1039/d2cc04882e.
19. Adili, A., Korpusik, A. B., Seidel, D., and Sumerlin, B. S. (2022). Photocatalytic Direct Decarboxylation of Carboxylic Acids to Derivatize or Degrade Polymers. Angew. Chem. Int. Ed. 32611. 10.1002/anie.202209085.
20. Garrison, J. B., Hughes, R. W., and Sumerlin, B. S. (2022). Backbone Degradation of Polymethacrylates via Metal-Free Ambient-Temperature Photoinduced Single-Electron Transfer. ACS Macro Lett. 11, 441-446. 10.1021/acsmacrolett.2c00091.
21. Garrison, J. B., Hughes, R. W., Young, J. B., and Sumerlin, B. S. (2022). Photoinduced SET to access olefin-acrylate copolymers. Polym. Chem. 13, 982-988. 10.1039/d1py01643a.
22. Neary, W. J., Isais, T. A., and Kennemur, J. G. (2019). Depolymerization of Bottlebrush Polypentenamers and Their Macromolecular Metamorphosis. J. Am. Chem. Soc. 141, 14220-14229. 10.1021/jacs.9b05560.
23. De Tommaso, J., and Dubois, J. L. (2021). Risk analysis on PMMA Recycling Economics. Polymers (Basel) 13. 10.3390/polym13162724.
24. Godiya, C. B., Gabrielli, S., Materazzi, S., Pianesi, M. S., Stefanini, N., and Marcantoni, E. (2019). Depolymerization of waste poly(methyl methacrylate) scraps and purification of depolymerized products. J. Environ. Manage. 231, 1012-1020. 10.1016/j.jenvman.2018.10.116.
25. K. Matyjaszewski, J. X. (2001). Atom transfer radical polymerization. Chem. Rev. 101, 2921-2990. 10.1002/9783527809080.cataz01278.
26. Matyjaszewski, K. (2012). Atom Transfer Radical Polymerization (ATRP): Current status and future perspectives. Macromolecules 45, 4015-4039. 10.1021/ma3001719.
27. Polymerization, R., and Dadashi-silab, S. (2020). Iron Catalysts in Atom Transfer Radical Polymerization. Molecules 25, 1648. 10.3390/molecules25071648.
28. Horn, M., and Matyjaszewski, K. (2013). Solvent effects on the activation rate constant in atom transfer radical polymerization. Macromolecules 46, 3350-3357. 10.1021/ma400565k.
29. Hill, M. R., Carmean, R. N., and Sumerlin, B. S. (2015). Expanding the Scope of RAFT Polymerization: Recent Advances and New Horizons. Macromolecules 48, 5459-5469. 10.1021/acs.macromol.5b00342.
30. Keddie, D. J., Moad, G., Rizzardo, E., and Thang, S. H. (2012). RAFT agent design and synthesis. Macromolecules 45, 5321-5342. 10.1021/ma300410v.
31. Moad, G., Rizzardo, E., and Thang, S. H. (2009). Living radical polymerization by the RAFT process A second update. Aust. J. Chem. 62, 1402-1472. 10.1071/CH09311.
32. Moad, G., Chiefari, J., Chong, YK., Krstina, J., Mayadunne, R. T., Postma, A., Rizzardo, E., and Thang, S. H. (2000). Living free radical polymerization with reversible addition-fragmentation chain transfer (the life of RAFT). Polym. Int. 49, 993-1001. 10.1002/1097-0126(200009)49:9<993::AID-PI506>3.0.CO; 2-6.
33. Perrier, S. (2017). 50th Anniversary Perspective: RAFT Polymerization—A User Guide. Macromolecules 50, 7433-7447. 10.1021/acs.macromol.7b00767.
34. Haddleton, D. M., Jasieczek, C. B., Hannon, M. J., and Shooter, A. J. (1997). Atom transfer radical polymerization of methyl methacrylate initiated by alkyl bromide and 2-pyridinecarbaldehyde imine copper(I) complexes. Macromolecules 30, 2190-2193. 10.1021/ma961074r.
35. Lessard, J. J., Scheutz, G. M., Hughes, R. W., and Sumerlin, B. S. (2020). Polystyrene-Based Vitrimers: Inexpensive and Recyclable Thermosets. ACS Appl. Polym. Mater. 2, 3044-3048. 10.1021/acsapm.0c00523.
36. Flanders, M. J., and Gramlich, W. M. (2018). Reversible-addition fragmentation chain transfer (RAFT) mediated depolymerization of brush polymers. Polym. Chem. 9, 2328-2335. 10.1039/c8py00446c.
37. Sano, Y, Konishi, T., Sawamoto, M., and Ouchi, M. (2019). Controlled radical depolymerization of chlorine-capped PMMA via reversible activation of the terminal group by ruthenium catalyst. Eur. Polym. J. 120, 109181. 10.1016/j.eurpolymj.2019.08.008.
38. Wang, H. S., Truong, N. P., Pei, Z., Coote, M. L., and Anastasaki, A. (2022). Reversing RAFT Polymerization: Near-Quantitative Monomer Generation Via a Catalyst-Free Depolymerization Approach. J. Am. Chem. Soc. 144, 4678-4684. 10.1021/jacs.2c00963.
39. Young, J. B., Bowman, J. I., Eades, C. B., Wong, A. J., and Sumerlin, B. S. (2022). Photoassisted Radical Depolymerization. ACS Macro Lett. 11, 1390-1395. 10.1021/acsmacrolett.2c00603.
40. Bellotti, V., Parkatzidis, K., Wang, H. S., De Alwis Watuthanthrige, N., Orfano, M., Monguzzi, A., Truong, N. P., Simonutti, R., and Anastasaki, A. (2022). Light-accelerated depolymerization catalyzed by Eosin Y Polym. Chem. 14, 253-258. 10.1039/d2py01383e.
41. Martinez, M. R., Schild, D., De Luca Bossa, F., and Matyjaszewski, K. (2022). Depolymerization of Polymethacrylates by Iron ATRP. Macromolecules 55, 10590-10599. 10.1021/acs.macromol.2c01712.
42. Martinez, M. R., De Luca Bossa, F., Olszewski, M., and Matyjaszewski, K. (2022). Copper(II) Chloride/Tris(2-pyridylmethyl)amine-Catalyzed Depolymerization of Poly(n-butyl methacrylate). Macromolecules 55, 78-87. 10.1021/acs.macromol.lc02246.
43. Martinez, M. R., Dadashi-Silab, S., Lorandi, F., Zhao, Y, and Matyjaszewski, K. (2021). Depolymerization of P(PDMS11MA) Bottlebrushes via Atom Transfer Radical Polymerization with Activator Regeneration. Macromolecules 54, 5526-5538. 10.1021/acs.macromol.lc00415.
44. Wan, L. R., Ruiz, R., Gao, H., Patel, K. C., and Albrecht, T. R. (2015). The Limits of Lamellae-Forming. ACS Nano 9, 7506-7514. 10.1021/acsnano.5b02613
45. Snow, R. D., and Frey, F. E. (1943). The Reaction of Sulfur Dioxide with Olefins: The Ceiling Temperature Phenomenon. J. Am. Chem. Soc. 65, 2417-2418. 10.1021/ja01252a052.
46. Danton, F. S., and Ivin, K. J. (1948). Reversibility of the propagation reaction in polymerization processes and its manifestation in the phenomenon of a “ceiling temperature.” Nature 162, 705-707. 10.1038/162705a0.
47. Postma, A., Davis, T. P., Moad, G., and O'Shea, M. S. (2005). Thermolysis of RAFT-synthesized polymers. A convenient method for trithiocarbonate group elimination. Macromolecules 38, 5371-5374. 10.1021/ma050402x.
48. King, R. W and DePuy, C. H. (1960). Pyrolitic Cis Eliminations. Chem. Rev. 60, 431-457. 10.1021/cr60207a001
49. Perrier, S., and Takolpuckdee, P. (2005). Macromolecular design via reversible addition-fragmentation chain transfer (RAFT)/xanthates (MADIX) polymerization. J. Polym. Sci., Part A: Polym. Chem. 43, 5347-5393. 10.1002/pola.20986.
50. Chong, B., Moad, A. G., Rizzardo, B. E., Skidmore, A. M., and A, S. H. T. (2006). Thermolysis of RAFT-Synthesized Poly (Methyl Methacrylate). Aust. J. Chem. 59, 755-762.
51. Bekanova, M. Z., Neumolotov, N. K., Jablanovid, A. D., Plutalova, A. V., Chernikova, E. V., and Kudryavtsev, Y V. (2019). Thermal stability of RAFT-based poly(methyl methacrylate): A kinetic study of the dithiobenzoate and trithiocarbonate end-group effect. Polym. Degrad. Stab. 164, 18-27. 10.1016/j.polymdegradstab.2019.03.017.
52. Whitfield, R., Anastasaki, A., Nikolaou, V., Jones, G. R., Engelis, N. G., Discekici, E. H., Fleischmann, C., Willenbacher, J., Hawker, C. J., and Haddleton, D. M. (2017). Universal Conditions for the Controlled Polymerization of Acrylates, Methacrylates, and Styrene via Cu(0)-RDRP. J. Am. Chem. Soc. 139, 1003-1010. 10.1021/jacs.6b11783.
53. Konkolewicz, D., Schroder, K., Buback, J., Bernhard, S., and Matyjaszewski, K. (2012). Visible light and sunlight photoinduced ATRP with ppm of Cu catalyst. ACS Macro Lett. 1, 1219-1223. 10.1021/mz300457e.
54. Szczepaniak, G., Jeong, J., Kapil, K., Dadashi-Silab, S., Yemeni, S. S., Ratajczyk, P., Lathwal, S., Schild, D. J., Das, S. R., and Matyjaszewski, K. (2022). Open-air green-light-driven ATRP enabled by dual photoredox/copper catalysis. Chem. Sci. 11540-11550. 10.1039/d2sc04210j.
55. Parkatzidis, K., Boner, S., Wang, H. S., and Anastasaki, A. (2022). Photoinduced Iron-Catalyzed ATRP of Renewable Monomers in Low-Toxicity Solvents: A Greener Approach. ACS Macro Lett. 11, 841-846. 10.1021/acsmacrolett.2c00302.
56. Nguyen, N. H., Rosen, B. M., Lligadas, G., and Percec, V. (2009). Surface-Dependent kinetics of Cu(0)-Wire-Catalyzed single-electron transfer living radical polymerization of methyl acrylate in DMSO at 25° C. Macromolecules 42, 2379-2386. 10.1021/ma8028562.
57. Hughes, R. W., Lott, M. E., Bowman, J. I., and Sumerlin, B. S. (2022). Excitation Dependence in Photoiniferter Polymerization. ACS Macro Lett. 12, 14-19. 10.1021/acsmacrolett.2c00683.
58. Lee, Y, Boyer, C., and Kwon, M. S. (2023). Photocontrolled RAFT polymerization: past, present, and future. Chem. Soc. Rev. 52, 3035-3097. 10.1039/dlcs00069a.
59. Bagheri, A. (2023). Application of RAFT in 3D Printing: Where Are the Future Opportunities?Macromolecules. 56, 1778-1797. 10.1021/acs.macromol.2c02585.
60. Hartlieb, M. (2022). Photo-Iniferter RAFT Polymerization. Macromol. Rapid Commun. 43. 2100514. 10.1002/marc.202100514.
61. Lehnen, Anne-Catherine.; Johannes Gurke.; Alain M. Bapolisi.; Martin Reifarth, M. Bekir.; M. H. (2023). Xanthate-supported photo-iniferter (XPI)-RAFT polymerization: facile and rapid access to complex macromolecules. Chem. Sci. 14, 593-603. 10.4324/9781003117711-5.
62. Lehnen, A.-C. C., Kurki, J. A. M. M., and Hartlieb, M. (2022). The difference between photo-iniferter and conventional RAFT polymerization: high livingness enables the straightforward synthesis of multiblock copolymers. Polym. Chem. 13, 1537-1546. 10.1039/d1py01530c.
63. Zhou, H., and Johnson, J. A. (2013). Photo-controlled Growth of Telechelic Polymers and End-linked Polymer Gels. Angew. Chem. Int. Ed. 125, 2291-2294. 10.1002/ange.201207966.
64. Easterling, C. P., Xia, Y, Zhao, J., Fanucci, G. E., and Sumerlin, B. S. (2019). Block Copolymer Sequence Inversion through Photoiniferter Polymerization. ACS Macro Lett. 8, 1461-1466. 10.1021/acsmacrolett.9b00716.
65. Carmean, R. N., Becker, T. E., Sims, M. B., and Sumerlin, B. S. (2017). Ultra-High Molecular Weights via Aqueous Reversible-Deactivation Radical Polymerization. Chem 2, 93-101. 10.1016/j.chempr.2016.12.007.
66. Rebecca A. Olson, Megan E. Lott, John B. Garrison, B. S. S., Olson, R. A., Lott, M. E., Garrison, J. B., Davidson, C. L. G., Trachsel, L., Pedro, D. I., Sawyer, W. G., and Sumerlin, B. S. (2022). Inverse Miniemulsion Photoiniferter Polymerization for the Synthesis of Ultra-High Molecular Weight Polymers. Macromolecules 55, 8451-8460. 10.1021/acs.macromol.2c01239.
67. Carmean, R. N., Sims, M. B., Figg, C. A., Hurst, P. J., Patterson, J. P., and Sumerlin, B. S. (2020). Ultrahigh Molecular Weight Hydrophobic Acrylic and Styrenic Polymers through Organic-Phase Photoiniferter-Mediated Polymerization. ACS Macro Lett. 9, 613-618. 10.1021/acsmacrolett.0c00203.
68. Wang, H. S., Truong, N. P., Jones, G. R., and Anastasaki, A. (2022). Investigating the Effect of End-Group, Molecular Weight, and Solvents on the Catalyst-Free Depolymerization of RAFT Polymers: Possibility to Reverse the Polymerization of Heat-Sensitive Polymers. ACS Macro Lett. 11, 1212-1216. 10.1021/acsmacrolett.2c00506.
69. Fu, Q., McKenzie, T. G., Tan, S., Nam, E., and Qiao, G. G. (2015). Tertiary amine catalyzed photo-induced controlled radical polymerization of methacrylates. Polym. Chem. 6, 5362-5368. 10.1039/c5py00840a.
70. Fu, Q., Xie, K., McKenzie, T. G., and Qiao, G. G. (2017). Trithiocarbonates as intrinsic photoredox catalysts and RAFT agents for oxygen tolerant controlled radical polymerization. Polym. Chem. 8, 1519-1526. 10.1039/c6py01994c.
71. Gentekos, D. T., Sifri, R. J., and Fors, B. P. (2019). Controlling polymer properties through the shape of the molecular-weight distribution. Nat. Rev. Mater. 4, 761-774. 10.1038/s41578-019-0138-8.
72. Whitfield, R., Truong, N. P., Messmer, D., Parkatzidis, K., Rolland, M., and Anastasaki, A. (2019). Tailoring polymer dispersity and shape of molecular weight distributions: Methods and applications. Chem. Sci. 10, 8724-8734. 10.1039/c9sc03546j.
73. Kottisch, V, Gentekos, D. T., and Fors, B. P. (2016). “shaping” the Future of Molecular Weight Distributions in Anionic Polymerization. ACS Macro Lett. 5, 796-800. 10.1021/acsmacrolett.6b00392.
74. Whitfield, R., Truong, N. P., and Anastasaki, A. (2021). Precise Control of Both Dispersity and Molecular Weight Distribution Shape by Polymer Blending. Angew. Chem. Int. Ed. 133, 19532-19537. 10.1002/ange.202106729.
75. Whitfield, R., Truong, N. P., Messmer, D., Parkatzidis, K., Rolland, M., and Anastasaki, A. (2019). Tailoring polymer dispersity and shape of molecular weight distributions: Methods and applications. Chem. Sci. 10, 8724-8734. 10.1039/c9sc03546j.
76. Corrigan, N., and Boyer, C. (2022). Living in the Moment: A Mathematically Verified Approach for Molecular Weight Distribution Analysis and Application to Data Storage. Macromolecules 55, 8960-8969. 10.1021/acs.macromol.2c00945.
77. Gentekos, D. T., and Fors, B. P. (2018). Molecular Weight Distribution Shape as a Versatile Approach to Tailoring Block Copolymer Phase Behavior. ACS Macro Lett. 7, 677-682. 10.1021/acsmacrolett.8b00295.
78. Rosenbloom, S. I., Sifri, R. J., and Fors, B. P. (2021). Achieving molecular weight distribution shape control and broad dispersities using RAFT polymerizations. Polym. Chem. 12, 5910-5915. 10.1039/d1py00399b.

### Example 2: Supplemental Information for Example 1

### Abbreviations

TTC: Trithiocarbonate
DTC: Dithiocarbamate
DTB-H: Dithiobenzoate
DTB-CN: cyano-dithiobenzoate
DTB-OMe: methoxy-dithiobenzoate

T₉₅: The temperature (° C.) at which 5% mass loss of functionalized PMMA is observed by TGA. The value represents a traditional T₉₅, e.g., PMMA depolymerized by 5%. In the case of dual functionality, the percent depolymerization is measured from T₉₅ until the start of T₅.

T₅: The temperature (° C.) at which 5% mass loss of functionalized PMMA is observed by TGA after an observed plateau in the TGA trace.

### Materials

All chemicals were used as received unless otherwise noted. Methyl methacrylate (MMA, Sigma-Aldrich, 99%) was passed through a plug of basic alumina to remove inhibitor immediately before use. Dichloromethane (DCM), acetone, dimethylsulfoxide (DMSO, ACS grade), N,N-dimethylformamide (DMF, ACS Grade), copper wire, and anhydrous magnesium sulfate were purchased from Fisher Chemical. a-Bromoisobutyryl bromide and 2,2′-bipyridine (Bpy) were purchased from Sigma-Aldrich. Ethyl a-bromoisobutyrate (EBIB, 98%) was purchased from Sigma-Aldrich. Copper(II) bromide (CuBr₂, 99%) was purchased from Alfa Aesar. Sodium iodide (99.5%) was purchased from Thermo Fisher Scientific. Methanol was purchased from VWR. 1-Ethyl-3-(3-dimethylaminopropyl)carbodiimide (EDC, 98.0%) and N-hydroxyphthalimide were purchased from TCI Chemicals. Deuterated chloroform (CDCl3, 99.8% with 0.05% v/v TMS) was purchased from Cambridge Isotope Laboratories. 2-Cyanopropan-2-yl N-methyl-N-(pyridin-4-yl)carbamodithioate (DTC) was purchased from Sigma-Aldrich (97%). The thiocarbonylthio compounds used in this study; 2-(dodecylthiocarbonothioylthio)-2-methylpropionic acid (DDMAT), 4-cyano-4-[(dodecylsulfanylthiocarbonyl)sulfanyl]pentanoic acid (CDP), 2-cyanoprop-2-yl dithiobenzoate (DTB-H), 2-cyanopropyl-2-yl(4-methoxy) dithiobenzoate (DTB-OMe), 2-cyanopropyl-2-yl(4-cyano) dithiobenzoate (DTB-CN) were synthesized according to previously reported literature procedures.¹⁻³ Phthalimidyl bromoisobutyrate was synthesized according to a previous literature report.⁴

### Instrumentation

### Nuclear Magnetic Resonance (NMR) Spectroscopy.

¹H NMR spectra were recorded using a Magritek Spinsolve Ultra 60 MHz benchtop spectrometer or INOVA 500 MHz spectrometer. Chemical shifts (δ) are given in parts per million (ppm) relative to TMS and referenced to residual protonated solvent purchased from Cambridge Isotope Laboratories, Inc. (CDCl₃: δ¹H 7.26 ppm, acetone-d₆: δ¹H 2.05 ppm).

### Size-Exclusion Chromatography (SEC).

SEC was performed in N,N-dimethylacetamide with 50 mM LiCl at 50° C. and a flow rate of 1.0 mL/min (Agilent isocratic pump, degasser, and autosampler; columns: Viscogel I-series 5 μm guard+two ViscoGel I-series G3078 mixed bed columns, molecular weight range 0-20 and 0-10,000 kg/mol). Detection consisted of Wyatt Optilab T-rEX refractive index detector operating at 658 nm and a Wyatt miniDAWN TREOS light scattering detector operating at 690 nm. Absolute molecular weights and molecular weight distributions were calculated using the Wyatt ASTRA software and dn/dc values obtained from 100% mass recovery methods.

### Thermogravimetric Analysis (TGA).

TGA experiments were collected on a TA 5500, equipped with an autosampler using a 100 μL platinum pan. Each sample was run after precipitation and vigorous drying under vacuum. Ramp experiments were heated at 10° C./min from room temperature to 500° C. under nitrogen flow (25 mL/min). All low-temperature TGA experiments were recorded using TA's Thermal Advantage for Q Series software.

### Tandem Mass Spectrometry.

A TA 5500 series TGA was equipped with an MKS DMS Series 11 mass spectrometer to analyze ion fragments from polymer samples. The instrument utilizes a 1-300 amu quadrupole mass filter with a closed ion source. Bar chart experiments were used to scan all ion fragments from polymer samples with peak jump mode used to detect discrete ions for tracking the generation of identifiable ions. All data were processed using ProcessEye software and exported as a text file to Origin.

### Differential Scanning Calorimetry (DSC).

DSC experiments were conducted on a TA Q2500 DSC (TA Instruments, New Castle, DE), equipped with an autosampler and refrigerated cooling system 90 using aluminum hermetic sealed pans. Ramp experiments were performed by heating DSC pans under nitrogen (25 mL/min) at 2° C./min from 0 to 120° C. and cooled from 120 to 0° C., with 5-min isotherms at each extreme. All DSC experiments were recorded using the Thermal Advantage for Q Series software from TA.

TABLE S1
PMMA polymers used in this study.

| | Thermally- | | | | |
|---|---|---|---|---|---|
| Entry | active End- | M_{n, SEC} | T₉₅ | T₅* | Depolymerization |
| Number | groups^{a} | (kg/mol)^{b} | (° C.)^{c} | (° C.)^{d} | (%)^{e} |
| 1a | TTC | 5.0 | 148 | 322 | 42, 26 |
| 1b | TTC | 15 | 149 | 321 | 37, 24 |
| 1c | TTC | 27 | 163 | 317 | 36, 25 |
| 1d | TTC | 58 | 183 | 327 | 16, 35 |
| 1e | TTC | 121 | 173 | 327 | 15, 38 |
| 2 | DTC | 8.1 | 157 | 315 | 28, 36 |
| 3 | DTB-CN | 5.3 | 179 | 328 | 7, 58 |
| 4 | DTB-H | 6.1 | 180 | 300 | 5, 56 |
| 5 | DTB-OMe | 5.9 | 185 | 276 | 4, 52 |
| 6 | I | 14.9 | 280 | 367 | 12, 0 |
| 7 | Br | 13.0 | 290 | 365 | 10, 0 |
| 8a | Phth | 5.0 | 220 | 375 | 65, 4 |
| 8b | Phth | 10.0 | 235 | 369 | 58, 7 |
| 8c | Phth | 22.2 | 233 | 362 | 54, 8 |
| 8d | Phth | 44.5 | 235 | 358 | 54, 3 |
| 8e | Phth | 87.4 | 240 | 349 | 65, 30 |
| 9a | Phth + TTC | 5.4 | 148 | 224 | 40, 52 |
| 9b | Phth + TTC | 8.7 | 175 | 279 | 39, 50 |
| 9c | Phth + TTC | 36 | 160 | 256 | 25, 49 |
| 9d | Phth + TTC | 54 | 157 | 230 | 23, 49 |
| 9e | Phth + TTC | 100 | 155 | 260 | 18, 42 |
| 9f | Phth + TTC | 980 | 158 | 225 | 12, 28 |

^{a}Poly(methyl methacrylate) polymers bearing thermally-active chain ends.
^{b}The number average molecular weight as determined by size-exclusion chromatography.
^{c}Temperature at which 5% mass loss was observed for the PMMA polymers by thermogravimetric analysis (TGA).
^{d}Temperature at which 5% mass loss was observed after the plateau seen in TGA.
^{e}The first number corresponds to the percent depolymerization up to the observed plateau seen by TGA, while the second number corresponds to the additional depolymerization percent observed up to the degradation temperature of PMMA synthesized by conventional free radical polymerization at 376° C.

TABLE S2
Identified ion masses utilizing TGA tandem mass spec

| Mass | |
|---|---|
| (AMU) | Identity |
| 15* | Methyl |
| 18* | Water |
| 28* | Ethylene, Nitrogen |
| 44* | Carbon Dioxide |
| 55* | Isobutylene |
| 59* | methyl formate |
| 69* | buta-1,3-dien-2-ol |
| 76* | Carbon Disulfide, benzyl diradical |
| 85* | Methacrylic acetate |
| 99-101 | Methyl Methacrylate |
| 102* | Methyl Pyruvate |
| 102* | 2-oxiranecarboxylic acid, methyl ester |
| 109* | 2,5-dimethyl-1,3,5-hexatriene, H⁺ |
| 110* | 2,5-dimethyl-1,5-hexadiene |
| 114* | Methyl 2-methyl-2-butenoate |
| 126* | Methyl 2-methyl-2,4-pentadienoate |
| 162* | N-hydroxyphthalimide |

*Ion fragments that are not present in ¹H NMR spectroscopy of bulk collected MMA

### Procedures

### Synthesis of 1,3-dioxoisoindolin-2-yl-2-(((dodecylthio)carbonothioyl)thio)-2-methyl- propanoate (Phth-TTC)

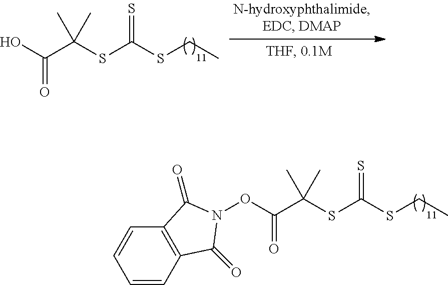

In a 50 mL RBF, DDMAT (100 mg, 0.274 mmol, 1 equiv), N-hydroxyphthalimide (179 mg, 1 mmol, 3.70 equiv), and EDC (192 mg, 1 mmol, 3.70 equiv) were dissolved in THE (10 mL) and stirred at 50° C. for 20 h. The yellow solution was concentrated to ¼ volume via rotary evaporation to yield a viscous, dark yellow solution. The product was purified by column chromatography in 70:30 dichloromethane/hexanes and dried under vacuum. H and ¹³C NMR spectroscopy confirmed the purity (FIGS. 14 and 15).

### Sample Polymerization Procedure for RAFT-Made PMMA-TTC

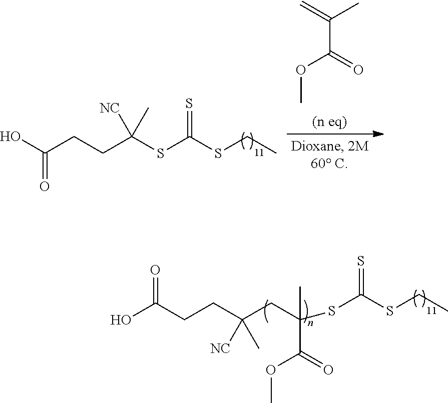

To a Schlenk flask CDP (180 mg, 0.46 mmol, 1.0 equiv), MMA (5.0 mL, 47 mmol, 100 equiv), and AIBN (7.5 mg, 0.046 mmol, 0.1 equiv) were dissolved in dioxane (4.0 mL) with trioxane as an internal standard (0.250 mg) and sparged under argon for 20 min. The solution was subsequently placed into a preheated oil bath (60° C.) until approximately 50% conversion was reached as determined by ¹H NMR spectroscopy. The final polymer was precipitated into methanol three times and dried vigorously under vacuum overnight (5.5 kg/mol, Ð=1.17). The same procedure was followed for all synthesized polymers with molecular weights predetermined by the equivalence of iniferter:monomer added. For higher molecular weight samples, photoiniferter polymerization methods were employed in which 450 nm light was used at 25° C. instead of AIBN and heat.

### Sample Polymerization Procedure for Photoiniferter-Made Phth-PMMA-TTC

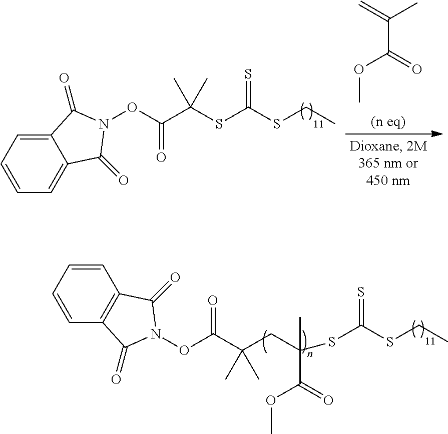

To a Schlenk flask Phth-TTC (320 mg, 0.63 mmol, 1.0 equiv) and MMA (6.8 mL, 63 mmol, 100 equiv) were dissolved in dioxane (4.0 mL) with trioxane as an internal standard (0.250 mg) and sparged under argon for 20 min. The solution was placed under blue light (450 nm) until approximately 50% conversion was reached by ¹H NMR. The final polymer was precipitated into methanol three times and dried vigorously under vacuum overnight (5.4 kg/mol, Ð=1.13). The same procedure was followed for all synthesized polymers with molecular weights predetermined by the equivalence of iniferter:monomer added.

Procedure for the SARA ATRP of MMA with Ethyl α-Bromoisobutyrate (EBIB)

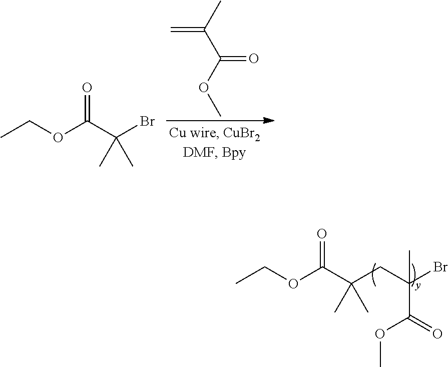

To a Schlenk flask MMA (2.61 mL, 24.5 mmol, 90 equiv) was combined with EBIB (0.04 mL, 0.273 mmol, 1.0 equiv), Bpy (8.5 mg, 0.0545 mmol, 0.20 equiv) and CuBr₂ (6.1 mg, 0.0273 mmol, 0.10 equiv) in DMF (100 vol %) with copper wire (1.7 cm) suspended above the solution. The solution was sparged with argon for 20 min at room temperature prior to introduction of the copper wire which initiated the polymerization. The final polymer was precipitated twice into cold methanol and the solvent was removed under reduced pressure to yield EBIB-PMMA-Br, which was characterized via SEC.

Sample Procedure for the SARA ATRP of MMA with Phthalimidyl Bromoisobutyrate (PhthBr)

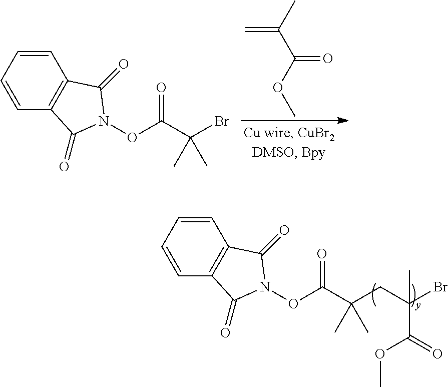

To a Schlenk flask MMA (2.13 mL, 20.0 mmol, 60 equiv) was combined with PhthBr (104 mg, 0.333 mmol, 1.0 equiv), Bpy (10.4 mg, 0.0667 mmol, 0.20 equiv) and CuBr₂ (7.4 mg, 0.0333 mmol, 0.10 equiv) in DMSO (100 vol %) with copper wire (1.7 cm) suspended above the solution. The solution was sparged with argon for 20 min at room temperature prior to introduction of the copper wire which initiated the polymerization. The final polymers were purified by dialysis against acetone or precipitation into cold methanol before removing the solvent under reduced pressure to yield pure Phth-PMMA-Br which was characterized by SEC with dispersities <1.10. The same procedure was followed for all synthesized polymers with molecular weights predetermined by the equivalence of initiator:monomer added.

### Finkelstein Reaction Procedure

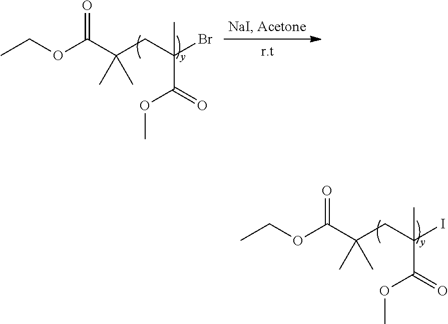

To a 20 mL round bottom flask, EBIB-PMMA-Br (0.200 g, 0.0138 mmol, 1.00 equiv), sodium iodide (0.103 g, 0.687 mmol, 50.0 equiv), and acetone (5 mL) were added. The reaction was allowed to stir at room temperature overnight. The reaction was filtered, and the solvent was removed before re-dissolving the polymer in DCM and precipitating into cold methanol. The resulting polymer was characterized by SEC and TGA.

### Sample Procedure for the Bulk Depolymerization of Phth-PMMA-TTC

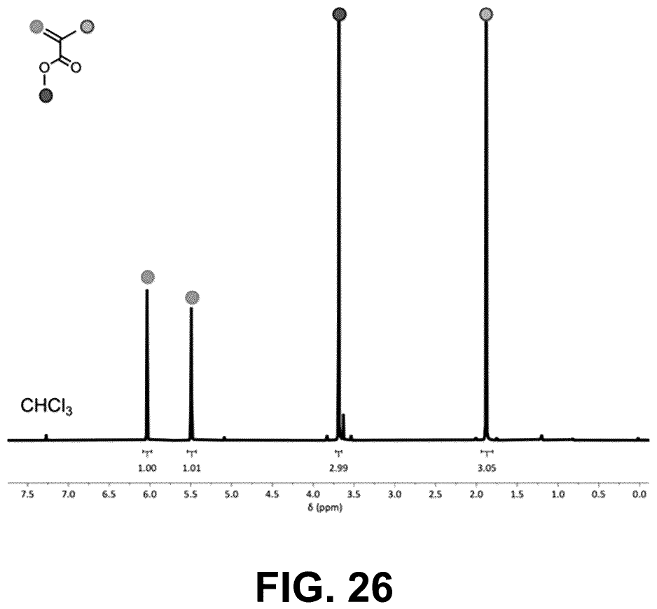

To a 25 mL round bottom flask, Phth-PMMA-TTC (1.097 g of 5.4 kg/mol) was added, and the flask was equipped with a condenser and a collection tube. The round bottom flask was lowered into a preheated sand bath (230° C.), and vacuum was applied to the distillation setup as needed to collect monomer. After approximately 1 h, the condensation of MMA was no longer observed, and monomer was collected (0.93 mL, 85% yield) with high purity as evidenced by the ¹H NMR spectrum (FIG. 26). The residual product was collected (0.086 g, 92% depolymerization conversion) and analyzed by ¹H NMR spectroscopy. The same preparation was taken for bulk depolymerization of PMMA-TTC (1.010 g) and Phth-PMMA (1.076 g).

### Sample Procedure for SCULPT Depolymerization

Solutions of 19.8 kg/mol Phth-PMMA-TTC (0.046 g/mL), 5.4 kg/mol Phth-PMMA-TTC (0.024 g/mL), and 12 kg/mol PMMA-H (0.031 g/mL) in DCM were premade for mixing in a scintillation vial prior to experimentation. A 1:1:1 (0.14 mL, 0.26 mL, and 0.20 mL) solution mixture containing an equal mass of each polymer was prepared and divided into 3 portions. One 0.1 mL portion was left to evaporate and used as a to time point while two 0.1 mL portions were placed into tared palladium TGA pans for isothermal holds of 20 and 40 min at 290° C., respectively. The solutions were left to dry on the TGA pans and first held at an isothermal hold of 50° C. for 10 min to ensure complete removal of DCM prior to depolymerization. The final polymer products were redissolved in 0.5M LiCl DMAC and prepped as SEC samples for molecular weight distribution analysis between the 0, 20, and 40 min isothermal holds.

### REFERENCES

1. Lai, J. T., Filla, D., and Shea, R. (2002). Functional polymers from novel carboxyl-terminated trithiocarbonates as highly efficient RAFT agents. Macromolecules 35, 122-123.
2. Moad, G., Chong, Y K., Postma, A., Rizzardo, E., and Thang, S. H. (2005). Advances in RAFT polymerization: The synthesis of polymers with defined end-groups. Polymer 46, 8458-8468. 10.1016/j.polymer.2004.12.061.
3. Young, J. B., Bowman, J I., Eades, C. B., Wong, A. J., and Sumerlin, B. S. (2022). Photoassisted Radical Depolymerization. ACS Macro Lett 11, 1390-1395. 10.1021/acsmacrolett.2c00603.
4. Garrison, J. B., Hughes, R. W., Young, J. B., and Sumerlin, B. S. (2022). Photoinduced SET to access olefin-acrylate copolymers. Polym Chem 13, 982-988. 10.1039/d1py01643a.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

What is claimed:

1. A composition comprising: a polymer having at least one of an α-chain end group (V) and an ω-chain end group (W), wherein V is selected from: 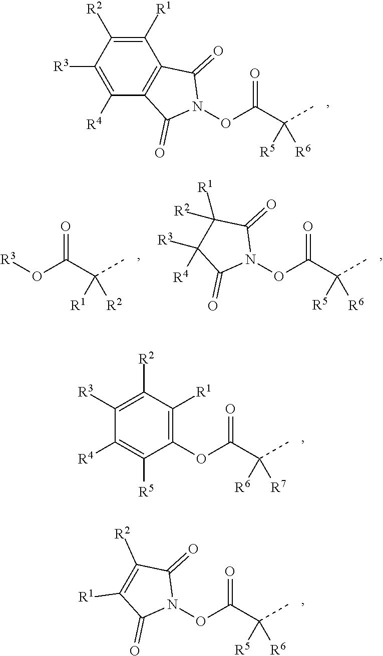
wherein W is selected from: 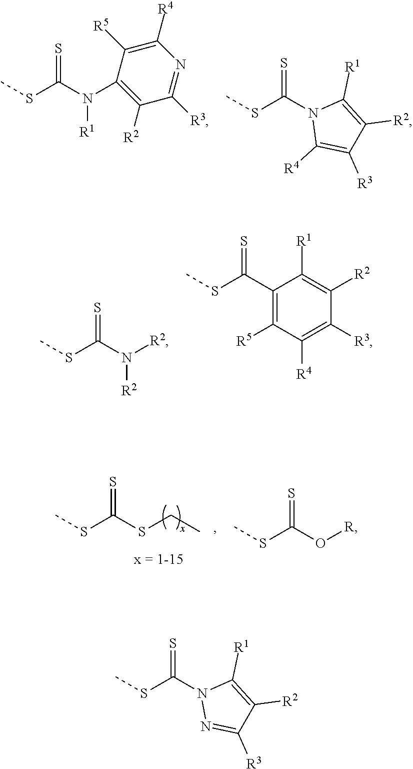
where the dashed line is the bond to the polymer, wherein x is 1 to 15, wherein each of R, R¹, R², R³, R⁴, R⁵, R⁶, and R⁷ are independently selected from: H, an alkyl group, halogen, —CN group, —NO₂ group, —O-alkyl group, an aryl group.

2. The composition of claim 1, wherein the polymer has the following polymer backbone: 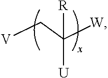
where R is an alkyl group or an H atom, x is 2 to 100,000, wherein U is a group that forms a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

3. The composition of claim 1, wherein the polymer is a block copolymer that has the following backbone: 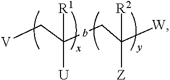
where R¹ is an alkyl group, x and y are independently 2 to 100,000, wherein U is a group that forms a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these, wherein Z and R² form a non-depolymerizable polymer block, wherein Z is a polystyrene group, a polyacrylate group, or a polyethylene group, wherein R² is an alkyl group or a hydrogen atom.

4. The composition of claim 2, wherein the monomer unit is the methacrylate monomer unit.

5. The composition of claim 4, wherein the methacrylate monomer unit is a methyl methacrylate monomer unit.

6. The composition of claim 2, wherein the monomer unit is the styrenic monomer unit.

7. The composition of claim 1, wherein the polymer is a homopolymer or a copolymer.

8. The composition of claim 7, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

9. The composition of claim 7, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

10. The composition of claim 1, wherein the V and W are both present.

11. A method of depolymerization of a polymer comprising:
adding at least one of an α-chain end group (V) and/or an ω-chain end group (W) to the polymer to form a modified polymer, wherein V is selected from: 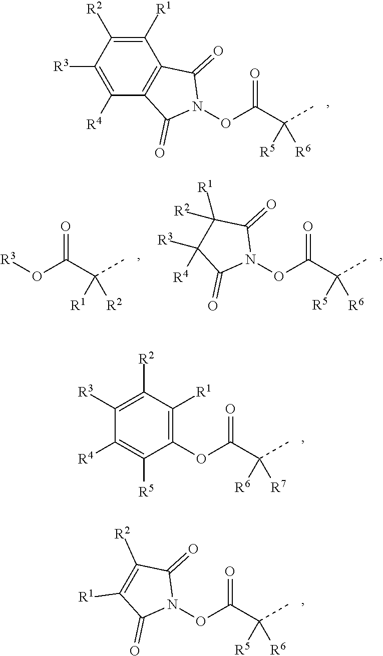
wherein W is selected from: 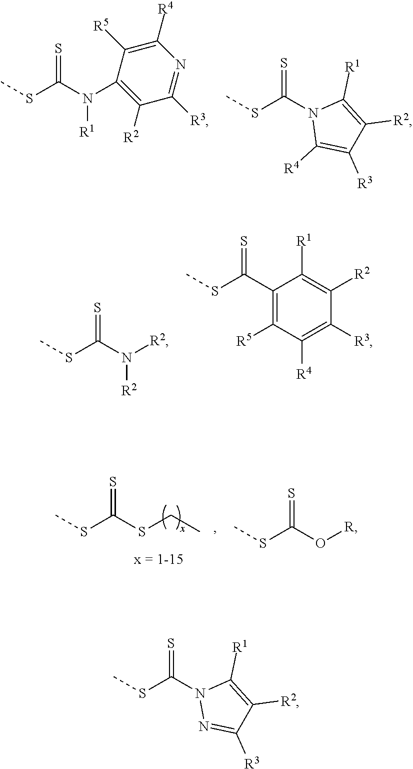
where the dashed line is the bond to the polymer, each of R, R¹, R², R³, R⁴, R⁵, R⁶, and R⁷ are independently selected from: H, an alkyl group, halogen, —CN group, —NO₂ group, —O-alkyl group, an aryl group,
heating the modified polymer to about 180 to 300° C.; and
depolymerization of the modified polymer, wherein about 90% of the monomer units are recovered.

12. The method of claim 11, wherein a molecular weight of the polymer is about 1-10000 kg/mol.

13. The method of claim 11, wherein the modified polymer is a homopolymer, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

14. The method of claim 11, wherein the modified polymer is a copolymer, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

15. The method of claim 13, wherein the monomer unit is the methacrylate monomer unit.

16. The method of claim 15, wherein the methacrylate monomer unit is a methyl methacrylate monomer unit.

17. The method of claim 13, wherein the monomer unit is the styrenic monomer unit.

18. A method of depolymerization a polymer comprising:
heating the polymer to about 180 to 300° C., wherein the polymer is selected from the polymer described in claim 1; and
depolymerization of the modified polymer, wherein about 90% of the monomer units are recovered.

19. The method of claim 18, wherein the polymer is a homopolymer, wherein the homopolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these; or
wherein the polymer is a copolymer, wherein the copolymer includes a monomer unit selected from: a methacrylate monomer, an acrylamide monomer, a methacrylamide monomer, an acrylate monomer, a styrenic monomer, a vinyl pyridine monomer, a maleimide monomer, a maleic anhydride-derived monomer, a vinyl ester monomer, a vinyl amide monomer, a vinyl halide monomer, a substituted acrylamide, a substituted methacrylamide, or a derivative of anyone of these.

20. The method of claim 19, wherein the monomer unit is the methacrylate monomer unit, wherein the methacrylate monomer unit is a methyl methacrylate monomer unit.
